(19) United States
(12) Patent Application Publication
(10) Pub. No.: US 2022/0150917 A1
(43) Pub. Date: May 12, 2022

(54) Channel Occupancy Time Interval in Unlicensed Frequency Spectrum

(71) Applicant: Telefonaktiebolaget LM Ericsson (publ), Stockholm (SE)

(72) Inventor: Min Wang, Luleå (SE)

(21) Appl. No.: 17/437,904

(22) PCT Filed: Jan. 29, 2020
(86) PCT No.: PCT/SE2020/050072

§ 371 Date: Sep. 10, 2021

Related U.S. Application Data
(60) Provisional application No. 62/818,953, filed on Mar. 15, 2019.

(51) Int. Cl. H04W 72/12; H04W 16/14

(52) U.S. Cl. CPC H04W 72/1242; H04W 72/1284; H04W 16/14

(57) ABSTRACT

According to some embodiments, a wireless device (14-1) is configured to transmit channel occupancy time, COT, information (20) to a radio network node (22). The COT information (20) indicates timing of, shareability of, and/or data prioritization for a COT interval (18) that the wireless device (14-1) initiates for occupying an unlicensed frequency channel (16). The wireless device (14-1) is also configured to receive different COT information (24) from the radio network node (22). The different COT information (24) indicates that the COT interval (18) initiated by the wireless device (14-1) is to have different timing, different shareability, and/or different data prioritization.

### TECHNICAL FIELD

The present application relates generally to wireless communication, and relates more specifically to use of unlicensed frequency spectrum for wireless communication.

### BACKGROUND

Before a transmitter is allowed to transmit within a channel occupancy time (COT) interval on an unlicensed frequency channel, the transmitter generally must determine that the channel is clear, e.g., based on a channel sensing procedure. However, according to a shared COT approach, after a transmitter initiates a COT interval by initiating transmission within that COT interval, the transmitter may share that COT interval with another transmitter, so that the other transmitter does not have to itself perform a channel sensing procedure. This advantageously reduces transmission latency for the other transmitter and/or avoids wasting resources that may have otherwise gone unused.

### SUMMARY

Challenges arise for COT sharing, when the transmitter that initiates a COT interval is a wireless device in a wireless communication network. In this case, it is the wireless device that heretofore controls the COT interval's timing and shareability. With little-to-no insight into transmission needs that currently exist or may later develop elsewhere in the network, the wireless device may control the COT interval in a way that neglects those transmission needs. This may in turn threaten to increase transmission latency in the network and thereby jeopardize the transmission latency reduction benefits of COT sharing.

According to some embodiments herein, a wireless device is configured to transmit channel occupancy time (COT) information to a radio network node. The COT information indicates information about a COT interval that the wireless device initiates for occupying an unlicensed frequency channel, e.g., in terms of the timing of, shareability of, and/or data prioritization for the COT interval. Notably, the radio network node is enabled by some embodiments herein to transmit different COT information to the wireless device, i.e., indicating different information about the COT interval. The different COT information may for example indicate that the COT interval initiated by the wireless device is to have different timing, different shareability, and/or different data prioritization.

Regardless of the particular nature or type of information conveyed by the different COT information, the radio network node in some embodiments transmits this different COT information to the wireless device as part of modifying the COT interval that the wireless device initiated. In one or more embodiments, the COT information that the wireless device transmitted just recommends, suggests, or tentatively configures certain timing, shareability, and/or data prioritization for the COT interval. In this case, the radio network node has ultimate decision-making authority in configuring the COT interval and may take the wireless device's recommendation, suggestion, or tentative configuration into account in doing so. In other embodiments, by contrast, the COT information that the wireless device transmitted represents an autonomous configuration of the COT interval that will stand absent the radio network node overriding that configuration by transmitting different COT information.

No matter the roles or nature of interaction between the radio network node and the wireless device, the radio network node may modify the COT interval with the different COT information in any number of ways and/or for any number of reasons. The radio network node may for example advantageously modify the COT interval as needed to account for transmission needs in the network, i.e., which the wireless device did not account for in initiating the COT interval.

More particularly, embodiments herein include a method performed by a wireless device. The method comprises transmitting, to a radio network node, channel occupancy time, COT, information indicating timing of, shareability of, and/or data prioritization for a COT interval that the wireless device initiates for occupying an unlicensed frequency channel. The method may also comprise receiving, from the radio network node, different COT information indicating that the COT interval initiated by the wireless device is to have different timing, different shareability, and/or different data prioritization.

In some embodiments, the method further comprises occupying the unlicensed frequency channel during the COT interval as modified by the radio network node to have the different timing, different shareability, and/or different data prioritization.

In some embodiments, the COT information indicates that the COT interval is not shareable with the radio network node and/or with other wireless devices, and the different COT information indicates that the COT interval is to be shareable with the radio network node and/or with other wireless devices.

In some embodiments, the COT information indicates a remaining duration of and/or a maximum duration of the COT interval, and the different COT information indicates that the COT interval is to have a different remaining duration and/or a different maximum duration.

In some embodiments, the COT information indicates a Listen Before Talk, LBT, priority class of data associated with the COT interval, and the different COT information indicates that the COT interval is to be associated with data that has a different LBT priority class.

Other embodiments herein include a method performed by a radio network node. The method comprises receiving, from a wireless device, channel occupancy time, COT, information indicating timing of, shareability of, and/or data prioritization for a COT interval that the wireless device initiates for occupying an unlicensed frequency channel. The method also comprises transmitting, to the wireless device, different COT information indicating that the COT interval initiated by the wireless device is to have different timing, different shareability, and/or different data prioritization.

In some embodiments, the method further comprises determining at least one of: whether the COT interval initiated by the wireless device is to have different timing, different shareability, and/or different data prioritization; or the different timing, different shareability, and/or different data prioritization.

In some embodiments, said determining is based on a priority of pending data and/or a priority of data already scheduled to be transmitted to or received from the wireless device within the COT interval, where the pending data is data not yet scheduled for transmission or reception.

In some embodiments, said determining is based on a volume of pending data relative to a threshold volume, where the pending data is data not yet scheduled for transmission or reception.

In some embodiments, the method further comprises: occupying the unlicensed frequency channel during the COT interval as modified by the radio network node to have the different timing, different shareability, and/or different data prioritization; or scheduling data to be transmitted to or received from one or more other wireless devices on the unlicensed frequency channel during the COT interval as modified by the radio network node to have the different timing, different shareability, and/or different data prioritization.

In some embodiments, the COT information indicates that the COT interval is not shareable with the radio network node and/or with other wireless devices, and the different COT information indicates that the COT interval is to be shareable with the radio network node and/or with other wireless devices.

In some embodiments, the COT information indicates a remaining duration of and/or a maximum duration of the COT interval, and the different COT information indicates that the COT interval is to have a different remaining duration and/or a different maximum duration.

In some embodiments, the COT information indicates a Listen Before Talk, LBT, priority class of data associated with the COT interval, and the different COT information indicates that the COT interval is to be associated with data that has a different LBT priority class.

Embodiments herein further include a method performed by a radio network node. The method comprises initiating, or receiving information indicating that a first wireless device has initiated, a first channel occupancy time, COT, interval during which a first transmission is to be performed between the radio network node and the first wireless device on a first set of one or more radio resources within an unlicensed frequency channel. The method may also comprise controlling initiation of a second COT interval during which a second transmission is to be performed between the radio network node and a second wireless device on a second set of one or more radio resources within the unlicensed frequency channel, where the second COT interval at least partly overlaps in time with the first COT interval.

In some embodiments, the second transmission is allowed during the second COT interval based on a channel sensing procedure performed by the radio network node or the first wireless device for the first COT interval.

In some embodiments, the second transmission has a priority level that is above a threshold and/or has a priority level that is above a priority level of the first transmission.

Embodiments herein also include corresponding apparatus, computer programs, and carriers such as non-transitory computer-readable mediums. For example, embodiments herein include a wireless device configured or adapted (e.g., via communication circuitry and processing circuitry) to transmit, to a radio network node, channel occupancy time, COT, information indicating timing of, shareability of, and/or data prioritization for a COT interval that the wireless device initiates for occupying an unlicensed frequency channel. The wireless device may also be configured or adapted to receive, from the radio network node, different COT information indicating that the COT interval initiated by the wireless device is to have different timing, different shareability, and/or different data prioritization.

Embodiments herein further include a radio network node. The radio network node is configured or adapted (e.g., via communication circuitry and processing circuitry) to receive, from a wireless device, channel occupancy time, COT, information indicating timing of, shareability of, and/or data prioritization for a COT interval that the wireless device initiates for occupying an unlicensed frequency channel. The radio network node may also be configured or adapted to transmit, to the wireless device, different COT information indicating that the COT interval initiated by the wireless device is to have different timing, different shareability, and/or different data prioritization.

Embodiments herein also include a radio network node. The radio network node is configured or adapted (e.g., via communication circuitry and processing circuitry) to initiate, or receive information indicating that a first wireless device has initiated, a first channel occupancy time, COT, interval during which a first transmission is to be performed between the radio network node and the first wireless device on a first set of one or more radio resources within an unlicensed frequency channel. The radio network node may also be configured or adapted to control initiation of a second COT interval during which a second transmission is to be performed between the radio network node and a second wireless device on a second set of one or more radio resources within the unlicensed frequency channel, where the second COT interval at least partly overlaps in time with the first COT interval.

### BRIEF DESCRIPTION OF THE DRAWINGS

FIG. 1 is a block diagram of a wireless communication network according to some embodiments.

FIG. 2 is a logic flow diagram of a method performed by a wireless device according to some embodiments.

FIG. 3 is a logic flow diagram of a method performed by a radio network node according to some embodiments.

FIG. 4 is a logic flow diagram of a method performed by a radio network node according to other embodiments.

FIG. 5 is a block diagram of a wireless device according to some embodiments.

FIG. 6 is a block diagram of a network node according to some embodiments.

FIG. 7 is a block diagram of transmission opportunities with and without COT sharing according to some embodiments.

FIG. 8 is a block diagram of COT sharing according to some embodiments.

FIG. 9 is a block diagram of a wireless communication network according to some embodiments.

FIG. 10 is a block diagram of a user equipment according to some embodiments.

FIG. 11 is a block diagram of a virtualization environment according to some embodiments.

FIG. 12 is a block diagram of a communication network with a host computer according to some embodiments.

FIG. 13 is a block diagram of a host computer communicating via a base station with a user equipment according to some embodiments.

FIG. 14 is a flowchart illustrating a method implemented in a communication system, in accordance with one embodiment.

FIG. 15 is a flowchart illustrating a method implemented in a communication system, in accordance with one embodiment.

FIG. 16 is a flowchart illustrating a method implemented in a communication system, in accordance with one embodiment.

FIG. 17 is a flowchart illustrating a method implemented in a communication system, in accordance with one embodiment.

### DETAILED DESCRIPTION

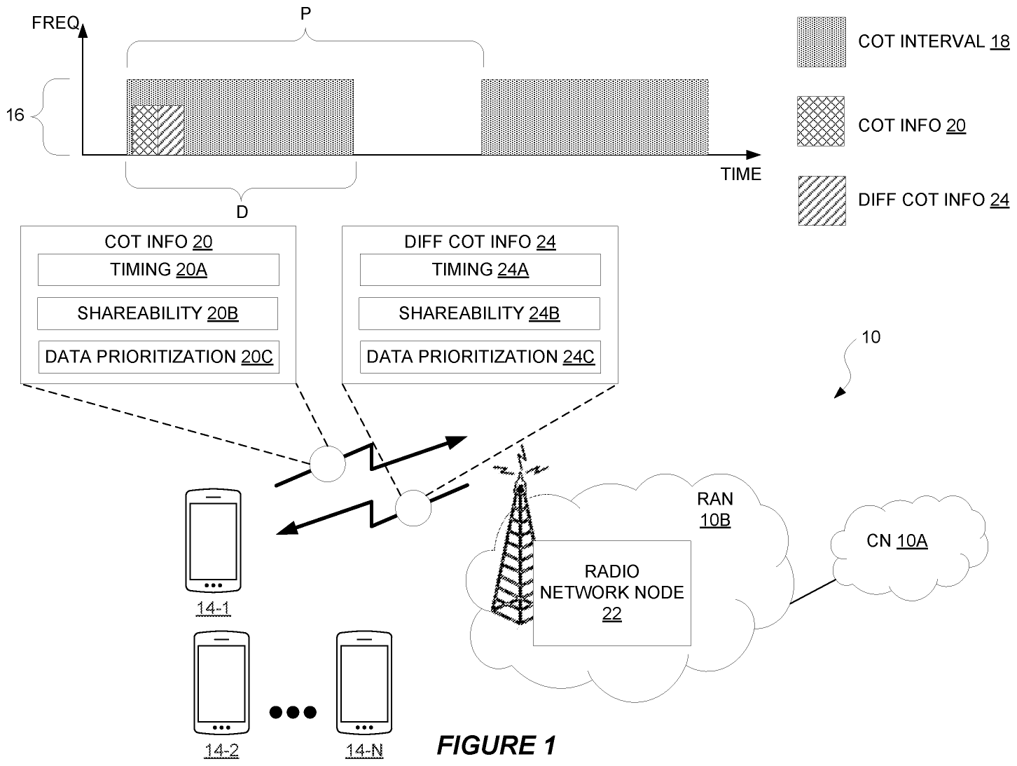

FIG. 1 shows a wireless communication network 10 (e.g., a New Radio Unlicensed, NR-U, network) according to some embodiments. The network 10 as shown includes a core network (CN) 10A that connects the network 10 to one or more other networks (e.g., the Internet). The network 10 also includes a radio access network (RAN) 10B that provides radio access to wireless devices 14-1 . . . 14-N, for connecting the wireless device(s) to the CN 10A.

The RAN 10A as shown in this regard is configured to provide radio access at least on an unlicensed frequency channel 16, e.g., an NR-U channel. The unlicensed frequency channel 16 may be unlicensed in the sense that it is not licensed (e.g., by an authoritative or governing entity) to any particular network operator for exclusive use. The unlicensed nature of the frequency channel 16 may therefore mean that the channel 16 is contentious, such that different wireless devices 14-1 . . . 14-N (even those using different radio access technologies) compete with one another in order to have the right to occupy the channel 16 for a limited amount of time. The first wireless device 14-1 . . . 14-N to determine that the channel 16 is free for use (e.g., by successfully completing a channel sensing procedure, such as a Listen-Before-Talk, LBT, procedure) wins the right to initiate a so-called channel occupancy time (COT) interval during which the wireless device is allowed to occupy the channel 16. This winning wireless device may initiate a COT interval by initiating transmission on the channel 16.

FIG. 1 for example shows that wireless device 14-1 initiates a COT interval 18 for occupying the unlicensed frequency channel 16. Before, after, or in conjunction with initiating the COT interval 18, the wireless device 14-1 according to some embodiments transmits certain COT information (“info”) 20 to a radio network node 22, e.g., that provides a cell or beam serving the wireless device 14-1. The COT information 20 may describe or characterize the COT interval 18 as initiated by the wireless device 14-1, e.g., in terms of the values of one or more parameters that the wireless device 14-1 chooses for configuring the COT interval 18.

The COT information 20 according to some embodiments indicates a timing 20A of the COT interval 18. The COT information 20 may for instance specify the timing 20A of the COT interval 18 in terms of a duration D of the COT interval 18, a remaining duration of the COT interval 18 (e.g., relative to when the COT information 20 is transmitted), a maximum duration of any COT interval, a period P of the COT interval 18 in case the COT interval 18 periodically recurs, and/or a time offset of the COT interval 18 relative to a reference time.

The COT information 20 may alternatively or additionally indicate a shareability 20B of the COT interval 18. The COT information 20 may for instance specify this shareability 20B in terms of whether the wireless device 14-1 that initiated the COT interval 18 gives the radio network node 22 permission to share the COT interval 18 with the wireless device 14-1. Alternatively or additionally, the COT information 20 may specify this shareability 20B in terms of whether the wireless device 14-1 that initiated the COT interval 18 gives other wireless devices 14-2 . . . 14-N that did not initiate the COT interval 18 permission to share the COT interval 18 with the wireless device 14-1. Or, the COT information 20 may specify this shareability 20B generically in terms of whether the wireless device 14-1 gives other transmitters generally permission to share the COT interval 18 with the wireless device 14-1. Regardless, the shareability 18 may additionally or alternatively be specified in terms of which periods (i.e., which periodic occurrences) of the COT interval 18 other transmitters (e.g., the radio network node 22, other wireless devices 14-2 . . . 14-N, etc.) are permitted to share with the wireless device 14-1.

In some embodiments, the COT information 20 alternatively or additionally indicates data prioritization 20C for the COT interval 18. The COT information 20 may for instance specify this data prioritization 20C in terms of an LBT priority class of data associated with the COT interval 18. Alternatively or additionally, the COT information 20 may specify the data prioritization 20C in terms of a service type of, logical channel of, logical channel group of, or channel access priority class (CAPC) of data associated with the COT interval 18.

Regardless of the particular nature or type of information conveyed by the COT information 20, the radio network node 22 according to some embodiments herein notably transmits different COT information 24 to the wireless device 14-1. In one embodiment, for instance, the radio network node 22 receives the COT information 20 from the wireless device 14-1, evaluates the COT information 20 (perhaps in conjunction with other information), and transmits the different COT information 24 to the wireless device 14-1 as a result of that evaluation. In this case, then, as shown, the radio network node 22 may transmit the different COT information 24 to the wireless device 14-1 after or in response to receiving the COT information 20 from the wireless device.

The different COT information 24 in some embodiments indicates that the COT interval 18 initiated by the wireless device 14-1 is to have different timing 24A than the timing 20A indicated by the COT information 20 received from the wireless device 14-1. For example, the different COT information 24 may indicate that the COT interval 18 is to have a different duration D′, a different remaining duration of the COT interval 18 (e.g., relative to when the COT information 20 was transmitted), a different maximum duration, a different period P′, and/or a different time offset relative to a reference time.

Alternatively or additionally, the different COT information 24 in some embodiments indicates that the COT interval 18 initiated by the wireless device 14-1 is to have different shareability 24B than the shareability 20B indicated by the COT information 20 received from the wireless device 14-1. For example, the different COT information 24 may indicate that the COT interval 18 is to be shareable with the radio network node 22 and/or with other wireless devices 14-2 . . . 14-N despite the COT information 20 from the wireless device 14-1 indicating that the wireless device 14-1 does not give permission for such sharing. As another example, the different COT information 24 may indicate that different periodic occurrences of the COT interval 18 are to be shareable (e.g., a greater number of them) than that indicated by the COT information 20 received from the wireless device 14-1.

Alternatively or additionally, the different COT information 24 in some embodiments indicates that the COT interval 18 initiated by the wireless device 14-1 is to have different data prioritization 24C than the data prioritization 20C indicated by the COT information 20 received from the wireless device 14-1. For example, the different COT information 24 may indicate that the COT interval 18 is to be associated with data that has a different LBT priority class, a different service type, a different logical channel, a different logical channel group, or a different channel access priority class than that indicated by the COT information 20 received from the wireless device 14-1.

Regardless of the particular nature or type of information conveyed by the different COT information 24, the radio network node 22 in some embodiments transmits this different COT information 24 to the wireless device 14-1 as part of modifying the COT interval 18 that the wireless device 14-1 initiated. In one or more embodiments, the COT information 20 that the wireless device 14-1 transmitted just recommends, suggests, or tentatively configures certain timing, shareability, and/or data prioritization for the COT interval 18. In this case, the radio network node 22 has ultimate decision-making authority in configuring the COT interval 18 and may take the wireless device's recommendation, suggestion, or tentative configuration into account in doing so. The different COT information 24 in this case may therefore reflect the radio network node's decision to configure the COT interval 16 differently than initially proposed by the wireless device 14-1. In other embodiments, by contrast, the COT information 20 that the wireless device 14-1 transmitted represents an autonomous configuration of the COT interval 18 that will stand absent the radio network node 22 overriding that configuration by transmitting different COT information 24.

No matter the roles or nature of interaction between the radio network node 22 and the wireless device 14-1, the radio network node 22 may modify the COT interval 18 with the different COT information 24 in any number of ways and/or for any number of reasons. The radio network node 22 may for example modify the COT interval 18 as needed to account for transmission needs in the network 10, i.e., which the wireless device 14-1 did not account for in initiating the COT interval 18. These transmission needs may have newly developed since the wireless device 14-1 initiated the COT interval 18 or may have previously existed when the wireless device 14-1 initiated the COT interval 18 but were not accounted for by the wireless device 14-1. In some embodiments, the radio network node 22 modifies the COT interval 18 as needed to account for these transmission needs, whether newly developed or previously existing.

Consider an example where the wireless device's COT information 20 indicates that the wireless device 14-1 does not give permission for the radio network node 22 and/or other wireless device 14-2 . . . 14-N to share the COT interval 18 with the wireless device 14-1. To account for high priority data (e.g., with low latency requirements) that the radio network node 22 needs to transmit to or receive from one or more other wireless devices 14-2 . . . 14-N, the radio network node 22 in some embodiments may effectively override the wireless device's decision or proposal not to share the COT interval 18. The radio network node 22 may do so by transmitting the different COT information 24 indicating that the COT interval 18 is indeed shareable. This way, the high priority data may be transmitted within the COT interval 18 so as to bypass the prerequisite for a clear channel assessment procedure and thereby reduce latency. Alternatively or additionally, the different COT information 24 may indicate that more and/or closer periodic occurrences of the COT interval 18 are to be shareable, e.g., so that opportunities for the high priority data transmission may occur more frequently and/or sooner in time.

Alternatively or additionally to dictating that the COT interval 18 be shareable to account for high priority data, the radio network node 22 may account for the high priority data by transmitting the different COT information 24 to indicate that the COT interval 18 is to have different timing 24A. This different timing 24A may for instance modify the COT interval 18 to have a duration or a remaining duration that is longer than the duration or remaining duration indicated by the COT information 20. Extending the COT interval's duration in this way may enable the high priority data to be transmitted within the COT interval 18, which would have otherwise been too short in duration to fit the high priority data. Alternatively or additionally to extending the COT interval's duration, the different timing 24A may indicate that the COT interval 18 is to have a period that is shorter than that indicated by the COT information 20. This way, the COT interval 18 may recur more frequently so as to provide more opportunities and/or less latency for high priority data transmissions. In still other embodiments, the different timing 24A may modify the COT interval 18 to have a duration or a remaining duration that is shorter than the duration or remaining duration indicated by the COT information 20. In fact, in one embodiment, the different timing 24A may effectively terminate the COT interval 18 right away. Shortening the COT interval's duration in these or other ways may enable the radio network node 22 or another wireless device to more quickly initiate a different COT interval within which the high priority data may be transmitted.

The radio network node 22 in some embodiments may selectively modify the COT interval 18 as described above only to account for data that has an absolute high priority level, e.g., as defined by a high priority level threshold. For example, the radio network node 22 may modify the COT interval 18 to account for data that has at least a certain LBT priority class or at least a certain channel access priority class (CAPC). In other embodiments, the radio network node 22 may modify the COT interval 18 to account for data that has a certain service type, or that is transmitted on a certain logical channel or within a certain logical channel group.

In other embodiments, the radio network node 22 may selectively modify the COT interval 18 as described above only to account for data that has a relatively high priority level, e.g., relative to a priority level of the data already scheduled to be transmitted to or received from the wireless device 14-1 within the COT interval 18. That is, only to account for data that is higher in priority than the already scheduled data for the wireless device 14-1.

In still other embodiments, the radio network node 22 may selectively modify the COT interval 18 as described above only if the data already scheduled to be transmitted to or received from the wireless device 14-1 within the COT interval 18 has an absolute low priority level, e.g., as defined by a low priority level threshold. For example, the radio network node 22 may modify the COT interval 18 only if the already scheduled data has an LBT priority class below a threshold or a channel access priority class (CAPC) below a threshold. In other embodiments, the radio network node 22 may modify the COT interval 18 only if the already scheduled data has a certain service type, or is transmitted on a certain logical channel or within a certain logical channel group.

Alternatively or additionally, the radio network node 22 in some embodiments may modify the COT interval 18 as described above to account for any volume of high priority data that the radio network node 22 needs to transmit or receive. The radio network node 22 in other embodiments however may condition modification of the COT interval 18 on the volume of high priority data exceeding a threshold. In this case, then, modification of the COT interval 18 may be performed for a “high” volume of high priority data.

Alternatively or additionally, the radio network node 22 in some embodiments may selectively modify the COT interval 18 as described above only if a high load condition is met. The high load condition may for instance be that the load of the unlicensed frequency channel exceeds a threshold. Or, the high load condition may be that the load of a cell, carrier, bandwidth part, or subband with which the unlicensed frequency channel is associated exceeds a threshold.

Note that the COT information 20 and/or the different COT information 24 may be conveyed by any type of control signaling and/or at any layer of a protocol stack implemented at the wireless device 14-1 and the radio network node 22. In some embodiments, for example, the COT information 20 is included in a Medium Access Control, MAC, Control Element or in a Radio Resource Control signaling message. Alternatively or additionally, the different COT information 24 may be included in a Medium Access Control, MAC, Control Element or in a Radio Resource Control signaling message. In still other embodiments, the COT information 20 may be included in configured grant uplink control information, CG-UCI. Alternatively or additionally, the different COT information 24 may be included in a downlink control information, DCI, message, e.g., that is addressed to a group of wireless devices including the wireless device or that is addressed to the wireless device.

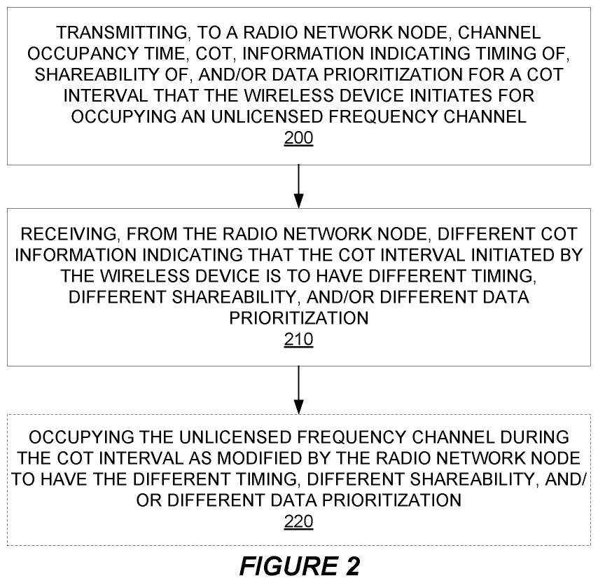

In view of the above modifications and variations, FIG. 2 depicts a method performed by a wireless device 14-1 in accordance with particular embodiments. The method includes transmitting, to a radio network node 22, channel occupancy time, COT, information 20 indicating timing of, shareability of, and/or data prioritization for a COT interval 18 that the wireless device 14-1 initiates for occupying an unlicensed frequency channel 16 (Block 200). The method also includes receiving, from the radio network node 22, different COT information 24 indicating that the COT interval 18 initiated by the wireless device 14-1 is to have different timing, different shareability, and/or different data prioritization (Block 210).

In some embodiments, the method may also include occupying the unlicensed frequency channel 16 during the COT interval 18 as modified by the radio network node 22 to have the different timing, different shareability, and/or different data prioritization (Block 220).

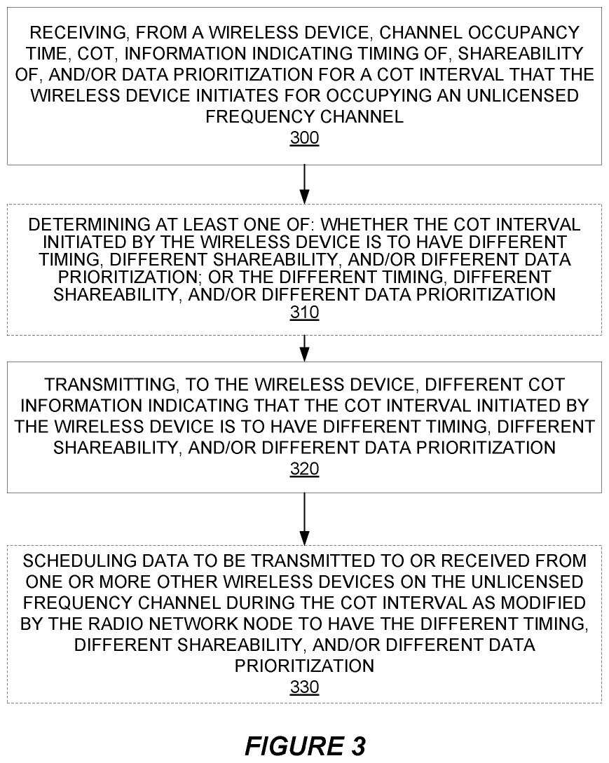

FIG. 3 depicts a method performed by a radio network node 22 in accordance with other particular embodiments. The method includes receiving, from a wireless device 14-1, channel occupancy time, COT, information 20 indicating timing of, shareability of, and/or data prioritization for a COT interval 18 that the wireless device 14-1 initiates for occupying an unlicensed frequency channel 16 (Block 300). The method also includes transmitting, to the wireless device 14-1, different COT information 24 indicating that the COT interval 18 initiated by the wireless device 14-1 is to have different timing, different shareability, and/or different data prioritization (Block 320).

In some embodiments, the method also includes determining at least one of: whether the COT interval initiated by the wireless device is to have different timing, different shareability, and/or different data prioritization; or the different timing, different shareability, and/or different data prioritization (Block 310).

Alternatively or additionally, the method may further include scheduling data to be transmitted to or received from one or more other wireless devices 14-2 . . . 14-N on the unlicensed frequency channel 16 during the COT interval 18 as modified by the radio network node 22 to have the different timing, different shareability, and/or different data prioritization (Block 330).

Some embodiments above have focused on the radio network node 22 controlling the COT interval 18 initiated by a wireless device 14-1 in such a way to enable that COT interval 18 to be shared with the radio network node 22 and/or other wireless devices 14-2 . . . 14-N. According to other embodiments herein, by contrast, the radio network node 22 may control initiation of a different COT interval so that it at least partially overlaps in time with another COT interval that has been initiated. Transmission within this overlapping COT interval may advantageously exploit the channel sensing procedure already performed for initiation of the other COT interval, so that transmission within the overlapping COT interval does not require yet another channel sensing procedure.

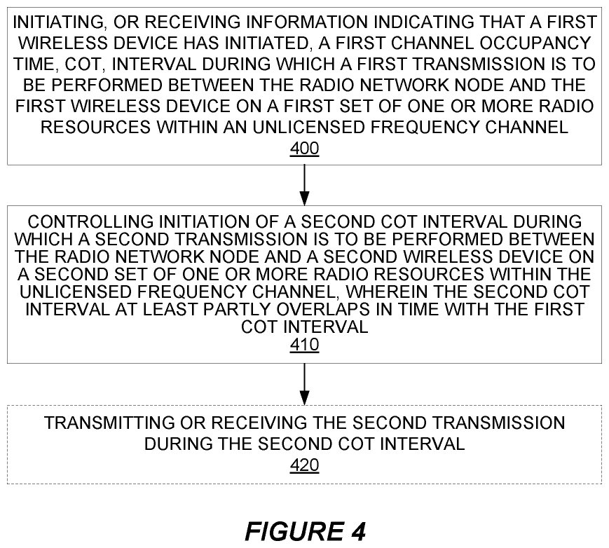

FIG. 4 depicts a method performed by a radio network node 22 in accordance with these other embodiments. The method includes initiating, or receiving information indicating that a first wireless device has initiated, a first channel occupancy time, COT, interval during which a first transmission is to be performed between the radio network node and the first wireless device on a first set of one or more radio resources within an unlicensed frequency channel (Block 400). The method also includes controlling initiation of a second COT interval during which a second transmission is to be performed between the radio network node and a second wireless device on a second set of one or more radio resources within the unlicensed frequency channel (Block 410). In some embodiments, the second COT interval at least partly overlaps in time with the first COT interval. In some embodiments, the second transmission is allowed during the second COT interval based on a channel sensing procedure performed by the radio network node or the first wireless device for the first COT interval.

In some embodiments, said controlling comprises initiating the second COT interval. In other embodiments, said controlling comprises scheduling the second transmission to be performed by the second wireless device that is to initiate the second COT interval.

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

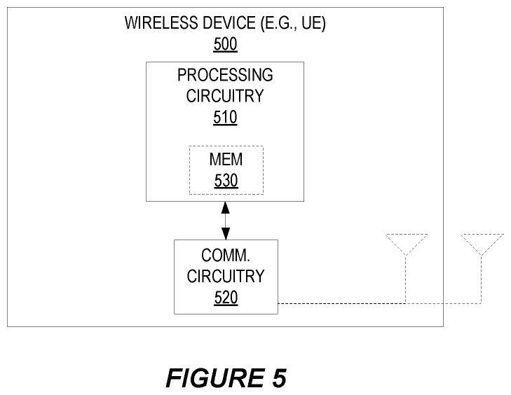

FIG. 5 for example illustrates a wireless device 500 (e.g., wireless device 14-1) as implemented in accordance with one or more embodiments. As shown, the wireless device 500 includes processing circuitry 510 and communication circuitry 520. The communication circuitry 520 (e.g., radio circuitry) is configured to transmit and/or receive information to and/or from one or more other nodes, e.g., via any communication technology. Such communication may occur via one or more antennas that are either internal or external to the wireless device 500. The processing circuitry 510 is configured to perform processing described above, e.g., in FIG. 2, such as by executing instructions stored in memory 530. The processing circuitry 510 in this regard may implement certain functional means, units, or modules.

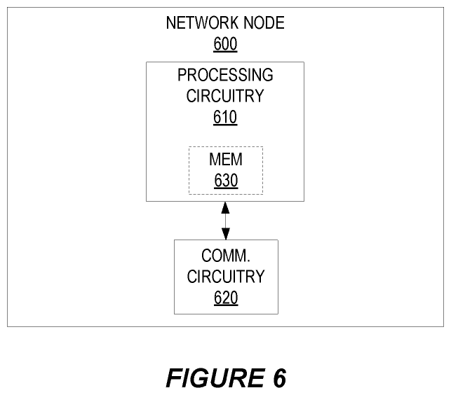

FIG. 6 illustrates a network node 600 (e.g., radio network node 22) as implemented in accordance with one or more embodiments. As shown, the network node 600 includes processing circuitry 610 and communication circuitry 620. The communication circuitry 620 is configured to transmit and/or receive information to and/or from one or more other nodes, e.g., via any communication technology. The processing circuitry 610 is configured to perform processing described above, e.g., FIG. 3 and/or FIG. 4, such as by executing instructions stored in memory 630. The processing circuitry 610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Next generation systems are expected to support a wide range of use cases with varying requirements ranging from fully mobile devices to stationary Internet-of-Things (IoT) or fixed wireless broadband devices. The traffic pattern associated with many use cases is expected to consist of short or long bursts of data traffic with varying length of waiting period in between (here called inactive state). In NR, both license assisted access and standalone unlicensed operation are to be supported in 3GPP. Hence the procedure of Physical Random Access Channel (PRACH) transmission and/or scheduling request (SR) transmission in unlicensed spectrum shall be investigated in 3GPP. In the following, NR-U and channel access procedure for an unlicensed channel based on LBT is introduced.

In order to tackle with the ever increasing data demand, NR is considered for both licensed and unlicensed spectrum. Compared to the Long Term Evolution (LTE) Licensed Assisted Access (LAA), NR-U also needs to support Dual Carrier (DC) and standalone scenarios, where the Medium Access Control (MAC) procedures including Random Access Channel (RACH) and scheduling procedure on unlicensed spectrum are subject to the LBT failures. There was no such restriction in Long Term Evolution (LTE) Licensed-Assisted Access (LAA), since there was licensed spectrum in LAA scenario so the RACH and scheduling related signaling can be transmitted on the licensed spectrum instead of unlicensed spectrum.

For NR-U, channel sensing should be applied to determine the channel available before a physical signal is transmitted using the channel. This is the case for discovery reference signal (DRS) transmission such as Primary Synchronization Signal (PSS), Secondary Synchronization Signal (SSS), Physical Broadcast Channel (PBCH), and Channel State Information Reference Signal (CSI-RS), control channel transmission such as Physical Uplink Control Channel (PUCCH) and Physical Downlink Control Channel (PDCCH), physical data channel such as Physical Uplink Shared Channel (PUSCH) and Physical Downlink Shared Channel (PDSCH), and uplink sounding reference signal (SRS) such as SRS transmission.

The radio resource management (RRM) procedures in NR-U would be generally rather similar as in LAA, since NR-U is aiming to reuse LAA/eLAA/feLAA technologies as much as possible to handle the coexistence between NR-U and other legacy radio access technologies (RATs). RRM measurements and report comprising special configuration procedure with respect the channel sensing and channel availability.

Hence, channel access/selection for LAA was one of the important aspects for co-existence with other RATs such as W-Fi. For instance, LAA has aimed to use carriers that are congested with W-Fi.

In licensed spectrum, a user equipment (UE) measures Reference Signal Received Power (RSRP), and Reference Signal Received Quality (RSRQ) of the downlink radio channel, and provides the measurement reports to its serving eNB/gNB. However, the measurement reports don't reflect the interference strength on the carrier. Another metric Received Signal Strength Indicator (RSSI) can serve for such purpose. At the eNB/gNB side, it is possible to derive RSSI based on the received RSRP and RSRQ reports. However, this requires that they must be available. Due to the LBT failure, some reports in terms of RSRP or RSRP may be blocked (can be either due to that the reference signal transmission (DRS) is blocked in the downlink or the measurement report is blocked in the uplink). Hence, the measurements in terms of RSSI are very useful. The RSSI measurements together with the time information concerning when and how long UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA has defined to support measurements of averaged RSSI and channel occupancy) for measurement reports. The channel occupancy is defined as a percentage of time that RSSI was measured above a configured threshold. For this purpose, a RSSI measurement timing configuration (RMTC) includes a measurement duration (e.g. 1-5 ms) and a period between measurements (e.g. {40, 80, 160, 320, 640} ms).

Listen-before-talk (LBT) is designed for unlicensed spectrum co-existence with other radio access technologies (RATs). In this mechanism, a radio device applies a clear channel assessment (CCA) check (i.e. channel sensing) before any transmission. The transmitter involves energy detection (ED) over a time period compared to a certain threshold (ED threshold) in order to determine if a channel is idle. In case the channel is determined to be occupied, the transmitter performs a random back-off within a contention window before its next CCA attempt. In order to protect the ACK transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MOOT)). For quality of service (QoS) differentiation, a channel access priority based on the service type has been defined. For example, there are four LBT priority classes defined for differentiation of contention window sizes (CWS) and MOOT between services.

For a node (e.g., NR-U gNB/UE, LTE-LAA eNB/UE, or Wi-Fi access point (AP)/station (STA)) to be allowed to transmit in unlicensed spectrum (e.g., 5 GHz band) it typically needs to perform a clear channel assessment (CCA). This procedure typically includes sensing the medium to be idle for a number of time intervals. Sensing the medium to be idle can be done in different ways, e.g. using energy detection, preamble detection or using virtual carrier sensing, where the latter implies that the node reads control information from other transmitting nodes informing when a transmission ends. After sensing the medium to be idle, the node is typically allowed to transmit for a certain amount of time, sometimes referred to as transmission opportunity (TXOP). The length of the TXOP depends on regulation and the type of CCA that has been performed, but typically ranges from 1 ms to 10 ms. This duration is often referred to as a COT (Channel Occupancy Time).

In Wi-Fi, feedback of data reception acknowledgements (ACKs) is transmitted without performing clear channel assessment. Preceding feedback transmission, a small time duration (called SIFS) is introduced between the data transmission and the corresponding feedback which does not include actual sensing of the channel. In 802.11, the SIFS period (16 ρs for 5 GHz OFDM PHYs) is defined as:

aSIFSTime=aRxPHYDelay+aMACProcessingDelay+aRxTxTurnaroundTime
aRxPHYDelay defines the duration needed by the PHY layer to deliver a packet to the MAC layer
aMACProcessingDelay defines the duration that the MAC layer needs to trigger the PHY layer transmitting a response
aRxTxTurnaroundTime defines the duration needed to turn the radio from reception into transmit mode
   Therefore, the SIFS duration is used to accommodate for the hardware delay to switch the direction from reception to transmission.

It is anticipated that for NR in unlicensed bands (NR-U), a similar gap to accommodate for the radio turnaround time will be allowed. For example, this will enable the transmission of a Physical Uplink Control Channel (PUCCH) carrying uplink control information (UCI) feedback as well as a Physical Uplink Shared Channel (PUSCH) carrying data and possible UCI within the same transmit opportunity (TXOP) acquired by the initiating gNB without the UE performing clear channel assessment before PUSCH/PUCCH transmission, as long as the gap between downlink (DL) and uplink (UL) transmission is less than or equal to a threshold time (e.g., 16 us). Operation in this manner is typically called “COT sharing.”

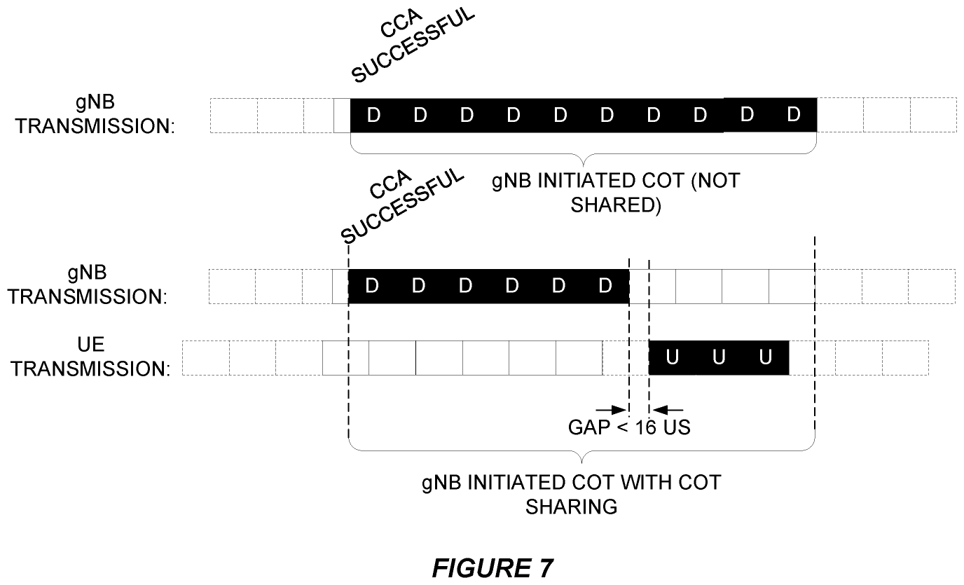

FIG. 7 shows an example of transmission opportunities (TXOP) both with and without COT sharing where CCA is performed by the initiating node (gNB). For the case of COT sharing, the gap between DL and UL transmission is less than 16 us.

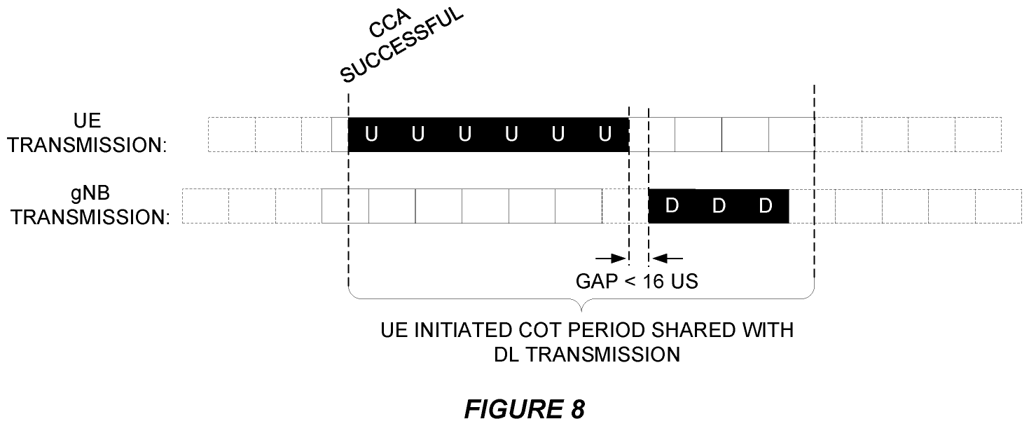

FIG. 8 shows a different example of COT sharing between a UE and gNB for the purpose of enabling a downlink (DL) transmission in the COT. When the UE accesses a medium via Cat-4 LBT with a configured grant outside of a gNB COT, it is possible for the UE and gNB to share the UE-acquired COT to schedule DL data to the same UE. UE COT information can be indicated in UCI such as configured grant UCI (CG-UCI) for configured grant PUSCH resources.

As described in 3GPP TR 38.889 “Study on NR-based access to unlicensed spectrum, Release 16”, v 16.0.0, the channel access schemes for NR-based access for unlicensed spectrum can be classified into the following categories: Category 1: Immediate transmission after a short switching gap
This is used for a transmitter to immediately transmit after a UL/DL switching gap inside a COT.
The switching gap from reception to transmission is to accommodate the transceiver turnaround time and is no longer than 16 μs.
   Category 2: LBT without random back-off
The duration of time that the channel is sensed to be idle before the transmitting entity transmits is deterministic.
   Category 3: LBT with random back-off with a contention window of fixed size
The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.
   Category 4: LBT with random back-off with a contention window of variable size
The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

For different transmissions in a COT and different channels/signals to be transmitted, different categories of channel access schemes can be used.

There currently exist certain challenge(s). The following parameters are included in Uplink Control Information (UCI): Hybrid Automatic Repeat Request (HARQ) ID, New Data Indicator (NDI), Redundancy Version (RV), and COT sharing information.

The following parameters are proposed to be included in Configured Grant UCI (CG-UCI):
Details on COT sharing information
   LBT Priority class value (channel access agenda)
   Remaining COT duration
   Signaling indicator for enabling/disabling COT sharing
UE-ID
CRC
Details on COT sharing information
   LBT Priority class value (channel access agenda)
   Remaining COT duration
PUSCH start and end point/slot
Resource configuration index
Starting position of a transmitted PUSCH
MCS/TBS, if enhancement on link adaptation is supported
CBGTI, if CBG based retransmission on configured grant resources is supported
   (see R1-1903476, “Outcome of offline discussion on Configured grant enhancement” 3GPP TSG RAN WG1 Meeting #96, Athens, Greece, Feb. 25-Mar. 1, 2019).

Based on this, when a UE initiates a channel occupancy with a transmission using a configured grant, it can signal at least the following:
The duration that the gNB is allowed to transmit in the channel occupancy initiated by the UE
   It is for further study how the duration is signaled, whether the UE should signal continued use of the COT for its own transmissions, and the LBT priority class.

Regarding the UE COT sharing, a UE can inform a gNB of the COT sharing information within a UE initiated COT. The COT sharing information would carry at least
1) Remaining COT duration
2) Signaling indicator for enabling/disabling COT sharing

For an UL transmission with a configured grant, the UE can look up a table with the correspondence between the logical channels and the LBT priority classes (Category 4 LBT) and determine from the LBT priority class the MCOT for the transmission. The table is configured/predefined by the gNB. In this fashion, the MCOT in the table would be a semi-static setting. Within the MCOT period occupied by the UE, the other UEs may have data with more critical QoS requirements arrived. Those UEs cannot however access the channel since the channel is blocked by the existing COT for a configured transmission, incurring additional user plane (UP) latency for those critical data. At the same time, the gNB may also have DL data with higher priority available for transmission. The DL data may be intended for the same UE who is occupying the UL COT, or the other UEs who don't own the channel. The DL data would not be scheduled until the UE shares the channel within the UL COT. However, it may occur that the shared COT period is too short so that it is not sufficient for the gNB to schedule the data with higher priority.

Problematically, if the gNB is only allowed to schedule the DL data for the same UE who owns the UL COT, the data intended for the other UEs would be even more restricted and suffer from additional UP latency.

Certain aspects of the present disclosure and their embodiments may provide solutions to these or other challenges. A method is proposed for the gNB to be able to override/update a UE COT in cases 1) there are data with higher priority arrived in the DL; and/or 2) the other UE may have data with higher priority arrived.

Some embodiments contrast with existing UE COT approaches that restrict COT sharing so that even high priority data is delayed for transfer until the existing UE COT quits. The high priority data in these existing approaches would suffer from the UP latency which may be not acceptable for QoS satisfaction. In some embodiments herein, by contrast, the gNB overrides the UE COT information to make the existing UE COT to share with the data transfer at the gNB and other UEs.

Certain embodiments may provide one or more of the following technical advantage(s). With proposed mechanisms,
1) Unnecessary LBT operations for high priority data are avoided within a COT. Therefore, the UP latency for the high priority data is reduced.
2) Avoid a UE COT blocking the channel so that the gNB or other UEs cannot access the channel for data transfer even though the UE COT occupies just part of the bandwidth. In this way, both fairness between UEs and system resource utilization are improved.

The below embodiments are described in the context of NR unlicensed spectrum (NR-U). Embodiments herein are not limited to NR-U scenarios though. They are also applicable to other unlicensed operation scenarios such as LTE LAA/e LAA/fe LAA.

As a first embodiment, when a UL COT is initiated by a UE, the UE is able to signal the sharing information to a gNB. The information may contain at least one of the below fields:
1) Indicators whether the COT is allowed to share (with the gNB and/or other UEs)
2) Remaining COT period
3) MCOT period
4) LBT priority class of the UE data associated with the COT
5) Indicators on service types/logical channel/logical channel group/channel access priority class (CAPC) of the UE data associated with the COT
6) Periods configured for sharing purpose. Each period may be configured by an offset and a duration. The offset and the period may be configured in the unit of slot or OFDM symbol.

Upon reception of the sharing information, the gNB may choose to override the UE COT if there is data with higher priority than the data the UE planned to deliver within the COT. In another example, the volume of the high priority data being above a configured threshold triggers the gNB to override/update existing UE COTs to release some resources for the high priority data. The high priority data may be in UL or DL, intended to the same UE or different UEs. The override actions may be selected from a set that includes one or more of the below options.

Option 1: the gNB decides/controls the UE COT to be also shared with other UEs. The sharing periods within the COT may need to increase for transmission of the high priority data. Alternatively or additionally, the gNB may reconfigure the UE COT structure to be able to carry more sharing periods, each sharing period may be also increased accordingly. The remaining COT period or the MCOT may alternatively or additionally be updated in accordance with the LBT priority class of the high priority data.

Option 2: the gNB decides to terminate the UE COT in advance since the high priority data has higher priority than the UE data planned for the COT. After the termination, the gNB can initiate another COT for the high priority data.

Option 3: the gNB doesn't override or update the UE COT. Instead, the gNB schedules the DL transmission intended to the UE within the UE COT. Meanwhile, if the resources are allowed, the gNB may start another DL COT for any other high priority data transmission intended to other UEs. The gNB may also schedule other UEs to start other UE COTs for those UEs have high priority UL data. All these COT can run in parallel with the existing UE COT. The other UEs may skip the LBT operation when initiating new COTs since they know that the channel has been already available to NR-U UEs (i.e., obtained by the initial UE and the gNB).

As a second embodiment, the override or update the UE COT is signaled by the gNB via signaling means such as:
1) a DCI addressed to a group of UEs, such as a group common PDCCH (GC-PDCCH) which may carry the updated UL COT information for multiple UEs
2) a DCI addressed to UE dedicated IDs such as Cell Radio Network Temporary Identity (C-RNTI), CS-RNTI etc;
3) a Medium Access Control (MAC) Control Element (CE) for a group of UEs or one or several specific UEs; or
4) an RRC signaling for a group of UEs or one or several specific UEs upon reception of the updated COT information, the UE updates its COT accordingly.

As a third embodiment, the UE may signal the UE COT information to a gNB via at least one of the below means:
1) included in the configured grant (CG)-UCI if the UE COT is initiated for CG transmissions. The CG-UCI may be carried on the PUSCH together with data or on the PUCCH channel;
2) included in a MAC CE; or
3) included in an RRC signaling message.

As a fourth embodiment, the function of UE COT override/update may be configured per UE basis. In other words, some UEs may support/be configured with the function while some other UEs may not support/be configured with the function. A UE capability bit may be introduced for support of this function.

As a fifth embodiment, the function of UE COT override/update may be configured per cell/carrier/BWP/channel/subband, where BWP stands for bandwidth part. In this way, some cell/carrier/BWP/channel/subband may enable the function of UE COT override/update in case high load/channel occupancy is detected. While, some cell/carrier/BWP/channel/subband may disable the function of UE COT override/update in case low load/channel occupancy is detected. In another example, the function of UE COT override can be dynamically enabled or disabled based on measured load/channel occupancy/LBT failure statistics, via signaling means such as a DCI, an RRC signaling or a MAC CE.

As a sixth embodiment, the function of UE COT override/update may be configured per channel access priority class (CAPC)/service/logical channel (LCH)/logical channel group (LCG). In this way, a specific service/CAPC/LCH/LCG may be configured on whether its COT can be override by the gNB.

A specific service/CAPC/LCH/LCG may be configured on whether it can override another UE COT, associated with other services. This can give configuration flexibility so that:
1) A UE COT may only be overriden/updated by a gNB in case the data already planned for transfer during the COT has a low priority level (e.g., in case the associated services/CAPCs/LCHs/LCGs of the planned data has a low priority level); and/or
2) A UE COT may only be overriden/updated by a gNB if the override/update would release resources for the transmission of other data which has a high priority level (e.g., in case the services/CAPCs/LCHs/LCGs associated with the other data has a high priority level).

As a seventh embodiment, in case the UE COT is shared with a gNB, the gNB may apply mini-slot based transmission in the DL intended for the UE to fit with the sharing periods. In this way, more transmission opportunities can be provided for the DL data. At the same time, the UE may apply slot based transmission in the UL. The UE would need to change its PDCCH monitoring pattern from a slot based pattern to a mini-slot based pattern when the COT is switched from UL to DL. After the DL data transmission, if the UE continues to use the COT for UL data transmission, the UE then needs to change back its PDCCH monitoring pattern from a mini-slot based pattern to a slot based pattern. The PDCCH monitoring pattern change for the UE can be configured or controlled by the gNB.

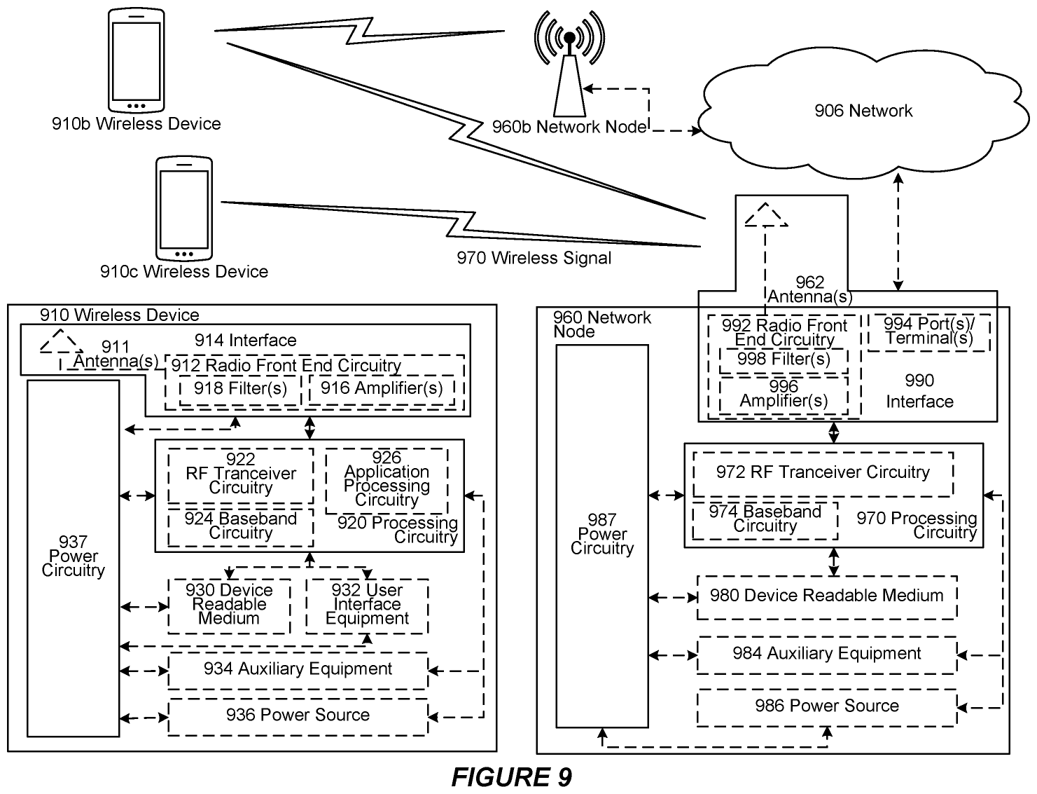

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 906, network nodes 960 and 960b, and WDs 910, 910b, and 910c. In practice, a wireless network may further include any additional elements suitable to support communication between wireless devices or between a wireless device and another communication device, such as a landline telephone, a service provider, or any other network node or end device. Of the illustrated components, network node 960 and wireless device (WD) 910 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 960 and WD 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 960 includes processing circuitry 970, device readable medium 980, interface 990, auxiliary equipment 984, power source 986, power circuitry 987, and antenna 962. Although network node 960 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 960 are depicted as single boxes located within a larger box, or nested within multiple boxes, in practice, a network node may comprise multiple different physical components that make up a single illustrated component (e.g., device readable medium 980 may comprise multiple separate hard drives as well as multiple RAM modules).

Similarly, network node 960 may be composed of multiple physically separate components (e.g., a NodeB component and a RNC component, or a BTS component and a BSC component, etc.), which may each have their own respective components. In certain scenarios in which network node 960 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 960 may be configured to support multiple radio access technologies (RATs). In such embodiments, some components may be duplicated (e.g., separate device readable medium 980 for the different RATs) and some components may be reused (e.g., the same antenna 962 may be shared by the RATs). Network node 960 may also include multiple sets of the various illustrated components for different wireless technologies integrated into network node 960, such as, for example, GSM, WCDMA, LTE, NR, WiFi, or Bluetooth wireless technologies. These wireless technologies may be integrated into the same or different chip or set of chips and other components within network node 960.

Processing circuitry 970 is configured to perform any determining, calculating, or similar operations (e.g., certain obtaining operations) described herein as being provided by a network node. These operations performed by processing circuitry 970 may include processing information obtained by processing circuitry 970 by, for example, converting the obtained information into other information, comparing the obtained information or converted information to information stored in the network node, and/or performing one or more operations based on the obtained information or converted information, and as a result of said processing making a determination.

Processing circuitry 970 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 960 components, such as device readable medium 980, network node 960 functionality. For example, processing circuitry 970 may execute instructions stored in device readable medium 980 or in memory within processing circuitry 970. Such functionality may include providing any of the various wireless features, functions, or benefits discussed herein. In some embodiments, processing circuitry 970 may include a system on a chip (SOC).

In some embodiments, processing circuitry 970 may include one or more of radio frequency (RF) transceiver circuitry 972 and baseband processing circuitry 974. In some embodiments, radio frequency (RF) transceiver circuitry 972 and baseband processing circuitry 974 may be on separate chips (or sets of chips), boards, or units, such as radio units and digital units. In alternative embodiments, part or all of RF transceiver circuitry 972 and baseband processing circuitry 974 may be on the same chip or set of chips, boards, or units

In certain embodiments, some or all of the functionality described herein as being provided by a network node, base station, eNB or other such network device may be performed by processing circuitry 970 executing instructions stored on device readable medium 980 or memory within processing circuitry 970. In alternative embodiments, some or all of the functionality may be provided by processing circuitry 970 without executing instructions stored on a separate or discrete device readable medium, such as in a hard-wired manner. In any of those embodiments, whether executing instructions stored on a device readable storage medium or not, processing circuitry 970 can be configured to perform the described functionality. The benefits provided by such functionality are not limited to processing circuitry 970 alone or to other components of network node 960, but are enjoyed by network node 960 as a whole, and/or by end users and the wireless network generally.

Device readable medium 980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 970. Device readable medium 980 may store any suitable instructions, data or information, including a computer program, software, an application including one or more of logic, rules, code, tables, etc. and/or other instructions capable of being executed by processing circuitry 970 and, utilized by network node 960. Device readable medium 980 may be used to store any calculations made by processing circuitry 970 and/or any data received via interface 990. In some embodiments, processing circuitry 970 and device readable medium 980 may be considered to be integrated.

Interface 990 is used in the wired or wireless communication of signalling and/or data between network node 960, network 906, and/or WDs 910. As illustrated, interface 990 comprises port(s)/terminal(s) 994 to send and receive data, for example to and from network 906 over a wired connection. Interface 990 also includes radio front end circuitry 992 that may be coupled to, or in certain embodiments a part of, antenna 962. Radio front end circuitry 992 comprises filters 998 and amplifiers 996. Radio front end circuitry 992 may be connected to antenna 962 and processing circuitry 970. Radio front end circuitry may be configured to condition signals communicated between antenna 962 and processing circuitry 970. Radio front end circuitry 992 may receive digital data that is to be sent out to other network nodes or WDs via a wireless connection. Radio front end circuitry 992 may convert the digital data into a radio signal having the appropriate channel and bandwidth parameters using a combination of filters 998 and/or amplifiers 996. The radio signal may then be transmitted via antenna 962. Similarly, when receiving data, antenna 962 may collect radio signals which are then converted into digital data by radio front end circuitry 992. The digital data may be passed to processing circuitry 970. In other embodiments, the interface may comprise different components and/or different combinations of components.

In certain alternative embodiments, network node 960 may not include separate radio front end circuitry 992, instead, processing circuitry 970 may comprise radio front end circuitry and may be connected to antenna 962 without separate radio front end circuitry 992. Similarly, in some embodiments, all or some of RF transceiver circuitry 972 may be considered a part of interface 990. In still other embodiments, interface 990 may include one or more ports or terminals 994, radio front end circuitry 992, and RF transceiver circuitry 972, as part of a radio unit (not shown), and interface 990 may communicate with baseband processing circuitry 974, which is part of a digital unit (not shown).

Antenna 962 may include one or more antennas, or antenna arrays, configured to send and/or receive wireless signals. Antenna 962 may be coupled to radio front end circuitry 990 and may be any type of antenna capable of transmitting and receiving data and/or signals wirelessly. In some embodiments, antenna 962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 962 may be separate from network node 960 and may be connectable to network node 960 through an interface or port.

Antenna 962, interface 990, and/or processing circuitry 970 may be configured to perform any receiving operations and/or certain obtaining operations described herein as being performed by a network node. Any information, data and/or signals may be received from a wireless device, another network node and/or any other network equipment. Similarly, antenna 962, interface 990, and/or processing circuitry 970 may be configured to perform any transmitting operations described herein as being performed by a network node. Any information, data and/or signals may be transmitted to a wireless device, another network node and/or any other network equipment.

Power circuitry 987 may comprise, or be coupled to, power management circuitry and is configured to supply the components of network node 960 with power for performing the functionality described herein. Power circuitry 987 may receive power from power source 986. Power source 986 and/or power circuitry 987 may be configured to provide power to the various components of network node 960 in a form suitable for the respective components (e.g., at a voltage and current level needed for each respective component). Power source 986 may either be included in, or external to, power circuitry 987 and/or network node 960. For example, network node 960 may be connectable to an external power source (e.g., an electricity outlet) via an input circuitry or interface such as an electrical cable, whereby the external power source supplies power to power circuitry 987. As a further example, power source 986 may comprise a source of power in the form of a battery or battery pack which is connected to, or integrated in, power circuitry 987. The battery may provide backup power should the external power source fail. Other types of power sources, such as photovoltaic devices, may also be used.

Alternative embodiments of network node 960 may include additional components beyond those shown in FIG. 9 that may be responsible for providing certain aspects of the network node's functionality, including any of the functionality described herein and/or any functionality necessary to support the subject matter described herein. For example, network node 960 may include user interface equipment to allow input of information into network node 960 and to allow output of information from network node 960. This may allow a user to perform diagnostic, maintenance, repair, and other administrative functions for network node 960.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 910 includes antenna 911, interface 914, processing circuitry 920, device readable medium 930, user interface equipment 932, auxiliary equipment 934, power source 936 and power circuitry 937. WD 910 may include multiple sets of one or more of the illustrated components for different wireless technologies supported by WD 910, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 910.

Antenna 911 may include one or more antennas or antenna arrays, configured to send and/or receive wireless signals, and is connected to interface 914. In certain alternative embodiments, antenna 911 may be separate from WD 910 and be connectable to WD 910 through an interface or port. Antenna 911, interface 914, and/or processing circuitry 920 may be configured to perform any receiving or transmitting operations described herein as being performed by a WD. Any information, data and/or signals may be received from a network node and/or another WD. In some embodiments, radio front end circuitry and/or antenna 911 may be considered an interface.

As illustrated, interface 914 comprises radio front end circuitry 912 and antenna 911. Radio front end circuitry 912 comprise one or more filters 918 and amplifiers 916. Radio front end circuitry 914 is connected to antenna 911 and processing circuitry 920, and is configured to condition signals communicated between antenna 911 and processing circuitry 920. Radio front end circuitry 912 may be coupled to or a part of antenna 911. In some embodiments, WD 910 may not include separate radio front end circuitry 912; rather, processing circuitry 920 may comprise radio front end circuitry and may be connected to antenna 911. Similarly, in some embodiments, some or all of RF transceiver circuitry 922 may be considered a part of interface 914. Radio front end circuitry 912 may receive digital data that is to be sent out to other network nodes or WDs via a wireless connection. Radio front end circuitry 912 may convert the digital data into a radio signal having the appropriate channel and bandwidth parameters using a combination of filters 918 and/or amplifiers 916. The radio signal may then be transmitted via antenna 911. Similarly, when receiving data, antenna 911 may collect radio signals which are then converted into digital data by radio front end circuitry 912. The digital data may be passed to processing circuitry 920. In other embodiments, the interface may comprise different components and/or different combinations of components.

Processing circuitry 920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 910 components, such as device readable medium 930, WD 910 functionality. Such functionality may include providing any of the various wireless features or benefits discussed herein. For example, processing circuitry 920 may execute instructions stored in device readable medium 930 or in memory within processing circuitry 920 to provide the functionality disclosed herein.

As illustrated, processing circuitry 920 includes one or more of RF transceiver circuitry 922, baseband processing circuitry 924, and application processing circuitry 926. In other embodiments, the processing circuitry may comprise different components and/or different combinations of components. In certain embodiments processing circuitry 920 of WD 910 may comprise a SOC. In some embodiments, RF transceiver circuitry 922, baseband processing circuitry 924, and application processing circuitry 926 may be on separate chips or sets of chips. In alternative embodiments, part or all of baseband processing circuitry 924 and application processing circuitry 926 may be combined into one chip or set of chips, and RF transceiver circuitry 922 may be on a separate chip or set of chips. In still alternative embodiments, part or all of RF transceiver circuitry 922 and baseband processing circuitry 924 may be on the same chip or set of chips, and application processing circuitry 926 may be on a separate chip or set of chips. In yet other alternative embodiments, part or all of RF transceiver circuitry 922, baseband processing circuitry 924, and application processing circuitry 926 may be combined in the same chip or set of chips. In some embodiments, RF transceiver circuitry 922 may be a part of interface 914. RF transceiver circuitry 922 may condition RF signals for processing circuitry 920.

In certain embodiments, some or all of the functionality described herein as being performed by a WD may be provided by processing circuitry 920 executing instructions stored on device readable medium 930, which in certain embodiments may be a computer-readable storage medium. In alternative embodiments, some or all of the functionality may be provided by processing circuitry 920 without executing instructions stored on a separate or discrete device readable storage medium, such as in a hard-wired manner. In any of those particular embodiments, whether executing instructions stored on a device readable storage medium or not, processing circuitry 920 can be configured to perform the described functionality. The benefits provided by such functionality are not limited to processing circuitry 920 alone or to other components of WD 910, but are enjoyed by WD 910 as a whole, and/or by end users and the wireless network generally.

Processing circuitry 920 may be configured to perform any determining, calculating, or similar operations (e.g., certain obtaining operations) described herein as being performed by a WD. These operations, as performed by processing circuitry 920, may include processing information obtained by processing circuitry 920 by, for example, converting the obtained information into other information, comparing the obtained information or converted information to information stored by WD 910, and/or performing one or more operations based on the obtained information or converted information, and as a result of said processing making a determination.

Device readable medium 930 may be operable to store a computer program, software, an application including one or more of logic, rules, code, tables, etc. and/or other instructions capable of being executed by processing circuitry 920. Device readable medium 930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 920. In some embodiments, processing circuitry 920 and device readable medium 930 may be considered to be integrated.

User interface equipment 932 may provide components that allow for a human user to interact with WD 910. Such interaction may be of many forms, such as visual, audial, tactile, etc. User interface equipment 932 may be operable to produce output to the user and to allow the user to provide input to WD 910. The type of interaction may vary depending on the type of user interface equipment 932 installed in WD 910. For example, if WD 910 is a smart phone, the interaction may be via a touch screen; if WD 910 is a smart meter, the interaction may be through a screen that provides usage (e.g., the number of gallons used) or a speaker that provides an audible alert (e.g., if smoke is detected). User interface equipment 932 may include input interfaces, devices and circuits, and output interfaces, devices and circuits. User interface equipment 932 is configured to allow input of information into WD 910, and is connected to processing circuitry 920 to allow processing circuitry 920 to process the input information. User interface equipment 932 may include, for example, a microphone, a proximity or other sensor, keys/buttons, a touch display, one or more cameras, a USB port, or other input circuitry. User interface equipment 932 is also configured to allow output of information from WD 910, and to allow processing circuitry 920 to output information from WD 910. User interface equipment 932 may include, for example, a speaker, a display, vibrating circuitry, a USB port, a headphone interface, or other output circuitry. Using one or more input and output interfaces, devices, and circuits, of user interface equipment 932, WD 910 may communicate with end users and/or the wireless network, and allow them to benefit from the functionality described herein.

Auxiliary equipment 934 is operable to provide more specific functionality which may not be generally performed by WDs. This may comprise specialized sensors for doing measurements for various purposes, interfaces for additional types of communication such as wired communications etc. The inclusion and type of components of auxiliary equipment 934 may vary depending on the embodiment and/or scenario.

Power source 936 may, in some embodiments, be in the form of a battery or battery pack. Other types of power sources, such as an external power source (e.g., an electricity outlet), photovoltaic devices or power cells, may also be used. WD 910 may further comprise power circuitry 937 for delivering power from power source 936 to the various parts of WD 910 which need power from power source 936 to carry out any functionality described or indicated herein. Power circuitry 937 may in certain embodiments comprise power management circuitry. Power circuitry 937 may additionally or alternatively be operable to receive power from an external power source; in which case WD 910 may be connectable to the external power source (such as an electricity outlet) via input circuitry or an interface such as an electrical power cable. Power circuitry 937 may also in certain embodiments be operable to deliver power from an external power source to power source 936. This may be, for example, for the charging of power source 936. Power circuitry 937 may perform any formatting, converting, or other modification to the power from power source 936 to make the power suitable for the respective components of WD 910 to which power is supplied.

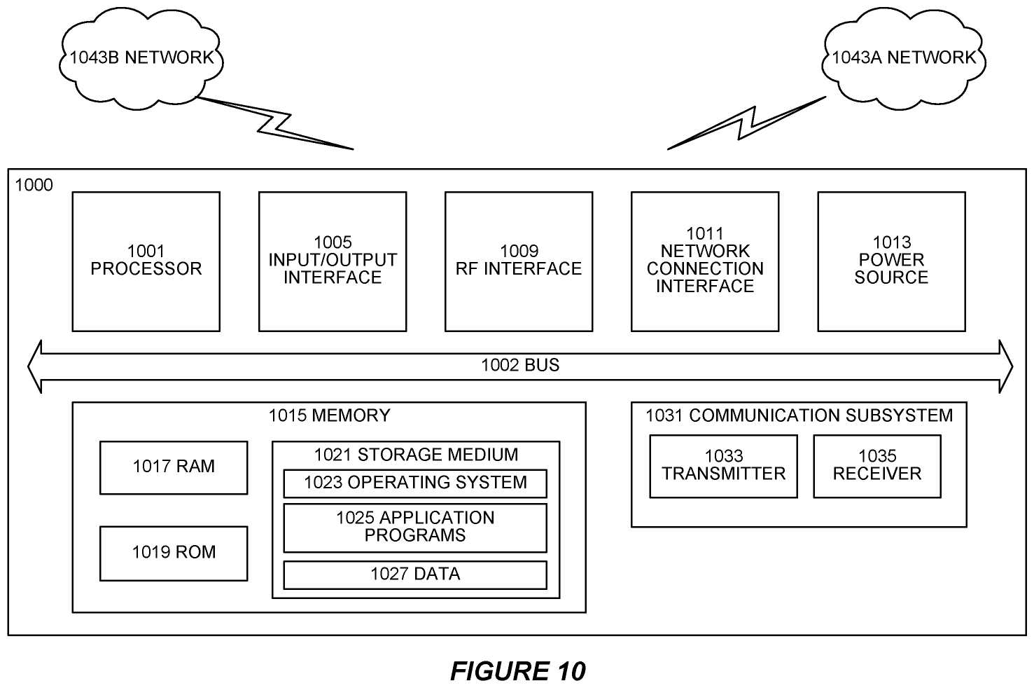

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 10200 may be any UE identified by the 3^{rd} Generation Partnership Project (3GPP), including a NB-IoT UE, a machine type communication (MTC) UE, and/or an enhanced MTC (eMTC) UE. UE 1000, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1000 includes processing circuitry 1001 that is operatively coupled to input/output interface 1005, radio frequency (RF) interface 1009, network connection interface 1011, memory 1015 including random access memory (RAM) 1017, read-only memory (ROM) 1019, and storage medium 1021 or the like, communication subsystem 1031, power source 1033, and/or any other component, or any combination thereof. Storage medium 1021 includes operating system 1023, application program 1025, and data 1027. In other embodiments, storage medium 1021 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1001 may be configured to process computer instructions and data. Processing circuitry 1001 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1001 may include two central processing units (CPUs). Data may be information in a form suitable for use by a computer.

In the depicted embodiment, input/output interface 1005 may be configured to provide a communication interface to an input device, output device, or input and output device. UE 1000 may be configured to use an output device via input/output interface 1005. An output device may use the same type of interface port as an input device. For example, a USB port may be used to provide input to and output from UE 1000. The output device may be a speaker, a sound card, a video card, a display, a monitor, a printer, an actuator, an emitter, a smartcard, another output device, or any combination thereof. UE 1000 may be configured to use an input device via input/output interface 1005 to allow a user to capture information into UE 1000. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1009 may be configured to provide a communication interface to RF components such as a transmitter, a receiver, and an antenna. Network connection interface 1011 may be configured to provide a communication interface to network 1043a. Network 1043a may encompass wired and/or wireless networks such as a local-area network (LAN), a wide-area network (WAN), a computer network, a wireless network, a telecommunications network, another like network or any combination thereof. For example, network 1043a may comprise a Wi-Fi network. Network connection interface 1011 may be configured to include a receiver and a transmitter interface used to communicate with one or more other devices over a communication network according to one or more communication protocols, such as Ethernet, TCP/IP, SONET, ATM, or the like. Network connection interface 1011 may implement receiver and transmitter functionality appropriate to the communication network links (e.g., optical, electrical, and the like). The transmitter and receiver functions may share circuit components, software or firmware, or alternatively may be implemented separately.

RAM 1017 may be configured to interface via bus 1002 to processing circuitry 1001 to provide storage or caching of data or computer instructions during the execution of software programs such as the operating system, application programs, and device drivers. ROM 1019 may be configured to provide computer instructions or data to processing circuitry 1001. For example, ROM 1019 may be configured to store invariant low-level system code or data for basic system functions such as basic input and output (I/O), startup, or reception of keystrokes from a keyboard that are stored in a non-volatile memory. Storage medium 1021 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1021 may be configured to include operating system 1023, application program 1025 such as a web browser application, a widget or gadget engine or another application, and data file 1027. Storage medium 1021 may store, for use by UE 1000, any of a variety of various operating systems or combinations of operating systems.

Storage medium 1021 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1021 may allow UE 1000 to access computer-executable instructions, application programs or the like, stored on transitory or non-transitory memory media, to off-load data, or to upload data. An article of manufacture, such as one utilizing a communication system may be tangibly embodied in storage medium 1021, which may comprise a device readable medium.

In FIG. 10, processing circuitry 1001 may be configured to communicate with network 1043b using communication subsystem 1031. Network 1043a and network 1043b may be the same network or networks or different network or networks. Communication subsystem 1031 may be configured to include one or more transceivers used to communicate with network 1043b. For example, communication subsystem 1031 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter 1033 and/or receiver 1035 to implement transmitter or receiver functionality, respectively, appropriate to the RAN links (e.g., frequency allocations and the like). Further, transmitter 1033 and receiver 1035 of each transceiver may share circuit components, software or firmware, or alternatively may be implemented separately.

In the illustrated embodiment, the communication functions of communication subsystem 1031 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1031 may include cellular communication, Wi-Fi communication, Bluetooth communication, and GPS communication. Network 1043b may encompass wired and/or wireless networks such as a local-area network (LAN), a wide-area network (WAN), a computer network, a wireless network, a telecommunications network, another like network or any combination thereof. For example, network 1043b may be a cellular network, a Wi-Fi network, and/or a near-field network. Power source 1013 may be configured to provide alternating current (AC) or direct current (DC) power to components of UE 1000.

The features, benefits and/or functions described herein may be implemented in one of the components of UE 1000 or partitioned across multiple components of UE 1000. Further, the features, benefits, and/or functions described herein may be implemented in any combination of hardware, software or firmware. In one example, communication subsystem 1031 may be configured to include any of the components described herein. Further, processing circuitry 1001 may be configured to communicate with any of such components over bus 1002. In another example, any of such components may be represented by program instructions stored in memory that when executed by processing circuitry 1001 perform the corresponding functions described herein. In another example, the functionality of any of such components may be partitioned between processing circuitry 1001 and communication subsystem 1031. In another example, the non-computationally intensive functions of any of such components may be implemented in software or firmware and the computationally intensive functions may be implemented in hardware.

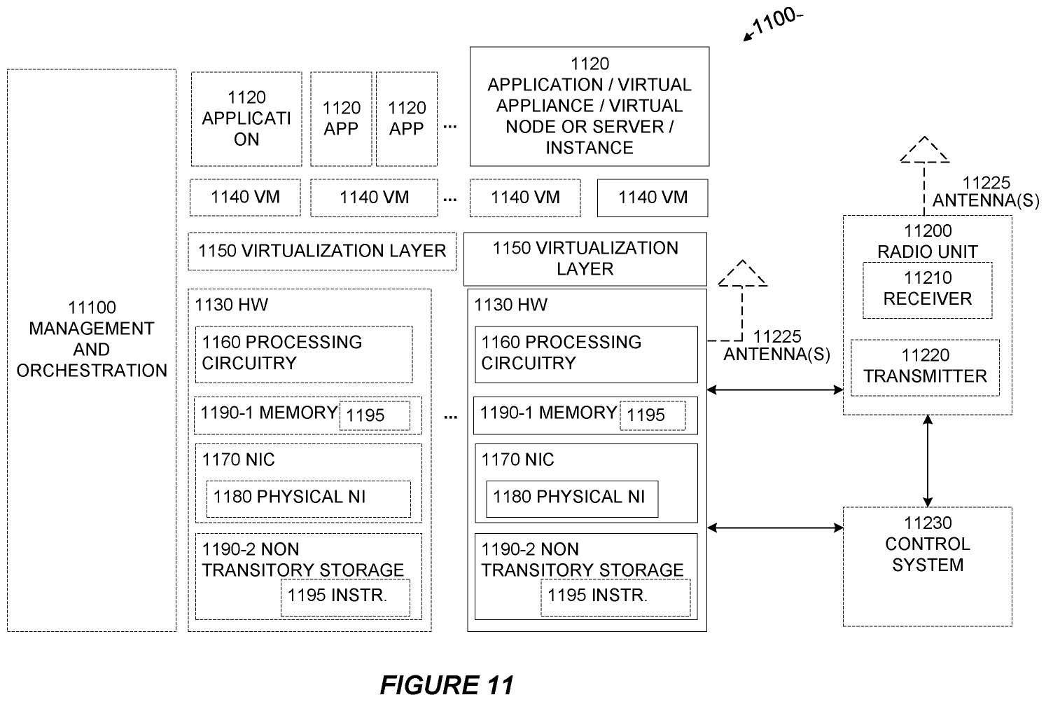

FIG. 11 is a schematic block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1100 hosted by one or more of hardware nodes 1130. Further, in embodiments in which the virtual node is not a radio access node or does not require radio connectivity (e.g., a core network node), then the network node may be entirely virtualized.

The functions may be implemented by one or more applications 1120 (which may alternatively be called software instances, virtual appliances, network functions, virtual nodes, virtual network functions, etc.) operative to implement some of the features, functions, and/or benefits of some of the embodiments disclosed herein. Applications 1120 are run in virtualization environment 1100 which provides hardware 1130 comprising processing circuitry 1160 and memory 1190. Memory 1190 contains instructions 1195 executable by processing circuitry 1160 whereby application 1120 is operative to provide one or more of the features, benefits, and/or functions disclosed herein.

Virtualization environment 1100, comprises general-purpose or special-purpose network hardware devices 1130 comprising a set of one or more processors or processing circuitry 1160, which may be commercial off-the-shelf (COTS) processors, dedicated Application Specific Integrated Circuits (ASICs), or any other type of processing circuitry including digital or analog hardware components or special purpose processors. Each hardware device may comprise memory 1190-1 which may be non-persistent memory for temporarily storing instructions 1195 or software executed by processing circuitry 1160. Each hardware device may comprise one or more network interface controllers (NICs) 1170, also known as network interface cards, which include physical network interface 1180. Each hardware device may also include non-transitory, persistent, machine-readable storage media 1190-2 having stored therein software 1195 and/or instructions executable by processing circuitry 1160. Software 1195 may include any type of software including software for instantiating one or more virtualization layers 1150 (also referred to as hypervisors), software to execute virtual machines 1140 as well as software allowing it to execute functions, features and/or benefits described in relation with some embodiments described herein.

Virtual machines 1140, comprise virtual processing, virtual memory, virtual networking or interface and virtual storage, and may be run by a corresponding virtualization layer 1150 or hypervisor. Different embodiments of the instance of virtual appliance 1120 may be implemented on one or more of virtual machines 1140, and the implementations may be made in different ways.

During operation, processing circuitry 1160 executes software 1195 to instantiate the hypervisor or virtualization layer 1150, which may sometimes be referred to as a virtual machine monitor (VMM). Virtualization layer 1150 may present a virtual operating platform that appears like networking hardware to virtual machine 1140.

As shown in FIG. 11, hardware 1130 may be a standalone network node with generic or specific components. Hardware 1130 may comprise antenna 11225 and may implement some functions via virtualization. Alternatively, hardware 1130 may be part of a larger cluster of hardware (e.g. such as in a data center or customer premise equipment (CPE)) where many hardware nodes work together and are managed via management and orchestration (MANO) 11100, which, among others, oversees lifecycle management of applications 1120.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1140 may be a software implementation of a physical machine that runs programs as if they were executing on a physical, non-virtualized machine. Each of virtual machines 1140, and that part of hardware 1130 that executes that virtual machine, be it hardware dedicated to that virtual machine and/or hardware shared by that virtual machine with others of the virtual machines 1140, forms a separate virtual network elements (VNE).

Still in the context of NFV, Virtual Network Function (VNF) is responsible for handling specific network functions that run in one or more virtual machines 1140 on top of hardware networking infrastructure 1130 and corresponds to application 1120 in FIG. 11.

In some embodiments, one or more radio units 11200 that each include one or more transmitters 11220 and one or more receivers 11210 may be coupled to one or more antennas 11225. Radio units 11200 may communicate directly with hardware nodes 1130 via one or more appropriate network interfaces and may be used in combination with the virtual components to provide a virtual node with radio capabilities, such as a radio access node or a base station.

In some embodiments, some signalling can be effected with the use of control system 11230 which may alternatively be used for communication between the hardware nodes 1130 and radio units 11200.

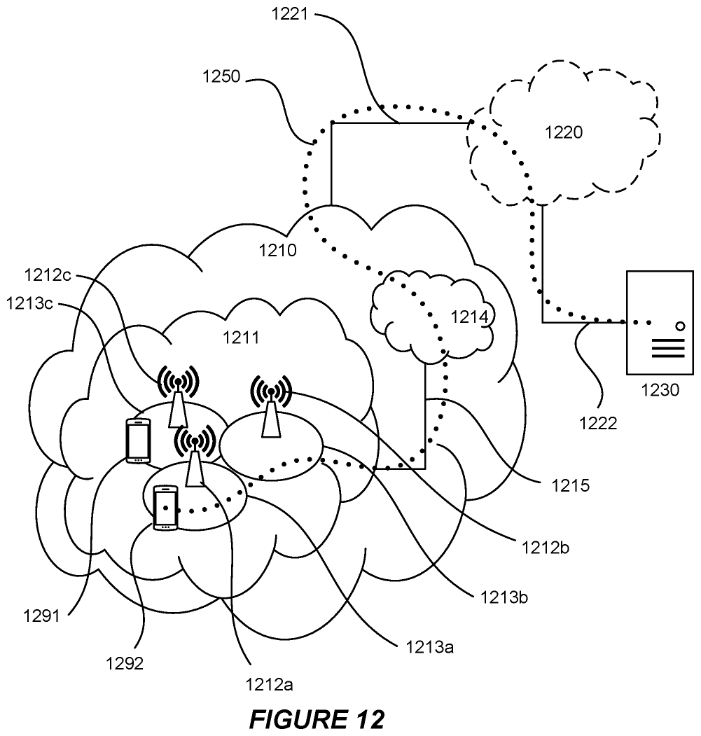

FIG. 12 illustrates a telecommunication network connected via an intermediate network to a host computer in accordance with some embodiments. In particular, with reference to FIG. 12, in accordance with an embodiment, a communication system includes telecommunication network 1210, such as a 3GPP-type cellular network, which comprises access network 1211, such as a radio access network, and core network 1214. Access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

Telecommunication network 1210 is itself connected to host computer 1230, which may be embodied in the hardware and/or software of a standalone server, a cloud-implemented server, a distributed server or as processing resources in a server farm. Host computer 1230 may be under the ownership or control of a service provider, or may be operated by the service provider or on behalf of the service provider. Connections 1221 and 1222 between telecommunication network 1210 and host computer 1230 may extend directly from core network 1214 to host computer 1230 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 1230. The connectivity may be described as an over-the-top (OTT) connection 1250. Host computer 1230 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 1230 to be forwarded (e.g., handed over) to a connected UE 1291. Similarly, base station 1212 need not be aware of the future routing of an outgoing uplink communication originating from the UE 1291 towards the host computer 1230.

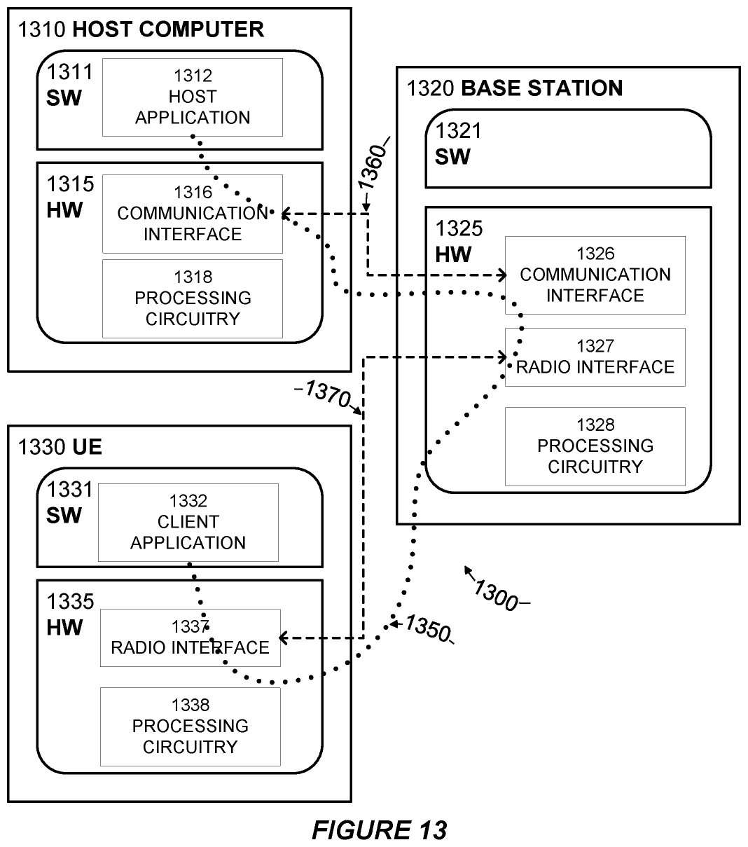

Example implementations, in accordance with an embodiment, of the UE, base station and host computer discussed in the preceding paragraphs will now be described with reference to FIG. 13. FIG. 13 illustrates host computer communicating via a base station with a user equipment over a partially wireless connection in accordance with some embodiments In communication system 1300, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318. Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350.

Communication system 1300 further includes base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 1230, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment. More precisely, the teachings of these embodiments may improve data latency, system fairness, and resource utilization and thereby provide benefits such as reduced user waiting time and better responsiveness.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

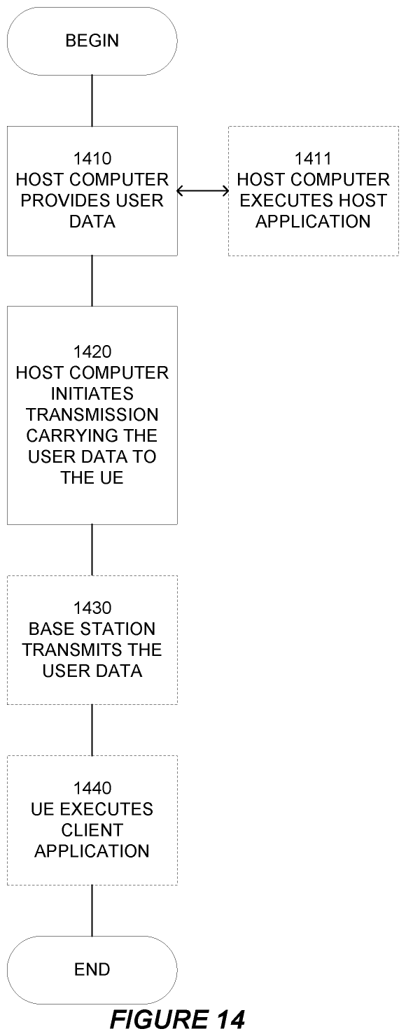

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1410, the host computer provides user data. In substep 1411 (which may be optional) of step 1410, the host computer provides the user data by executing a host application. In step 1420, the host computer initiates a transmission carrying the user data to the UE. In step 1430 (which may be optional), the base station transmits to the UE the user data which was carried in the transmission that the host computer initiated, in accordance with the teachings of the embodiments described throughout this disclosure. In step 1440 (which may also be optional), the UE executes a client application associated with the host application executed by the host computer.

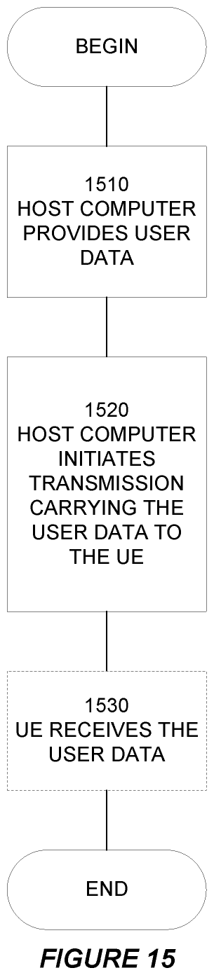

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1510 of the method, the host computer provides user data. In an optional substep (not shown) the host computer provides the user data by executing a host application. In step 1520, the host computer initiates a transmission carrying the user data to the UE. The transmission may pass via the base station, in accordance with the teachings of the embodiments described throughout this disclosure. In step 1530 (which may be optional), the UE receives the user data carried in the transmission.

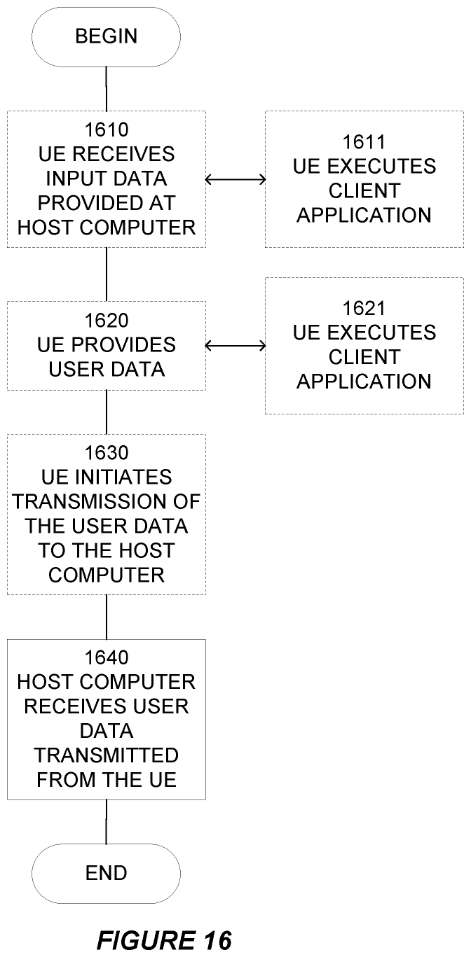

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1610 (which may be optional), the UE receives input data provided by the host computer. Additionally or alternatively, in step 1620, the UE provides user data. In substep 1621 (which may be optional) of step 1620, the UE provides the user data by executing a client application. In substep 1611 (which may be optional) of step 1610, the UE executes a client application which provides the user data in reaction to the received input data provided by the host computer. In providing the user data, the executed client application may further consider user input received from the user. Regardless of the specific manner in which the user data was provided, the UE initiates, in substep 1630 (which may be optional), transmission of the user data to the host computer. In step 1640 of the method, the host computer receives the user data transmitted from the UE, in accordance with the teachings of the embodiments described throughout this disclosure.

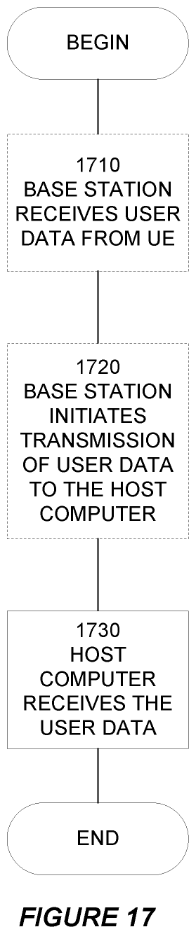

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1710 (which may be optional), in accordance with the teachings of the embodiments described throughout this disclosure, the base station receives user data from the UE. In step 1720 (which may be optional), the base station initiates transmission of the received user data to the host computer. In step 1730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Example embodiments of the techniques and apparatus described herein include, but are not limited to, the following enumerated examples:

### Group A Embodiments

A1. A method performed by a wireless device, the method comprising:
transmitting, to a radio network node, channel occupancy time, COT, information indicating timing of, shareability of, and/or data prioritization for a COT interval that the wireless device initiates for occupying an unlicensed frequency channel; and
receiving, from the radio network node, different COT information indicating that the COT interval initiated by the wireless device is to have different timing, different shareability, and/or different data prioritization.
   A2. The method of embodiment A1, further comprising occupying the unlicensed frequency channel during the COT interval as modified by the radio network node to have the different timing, different shareability, and/or different data prioritization.
   A3. The method of any of embodiments A1-A2, wherein the COT information indicates that the COT interval is not shareable with the radio network node and/or with other wireless devices, and wherein the different COT information indicates that the COT interval is to be shareable with the radio network node and/or with other wireless devices.
   A4. The method of any of embodiments A1-A3, wherein the COT information indicates a remaining duration of and/or a maximum duration of the COT interval, and wherein the different COT information indicates that the COT interval is to have a different remaining duration and/or a different maximum duration.
   A5. The method of any of embodiments A1-A4, wherein the COT interval is configured to periodically recur, wherein the COT information indicates a period of the COT interval and/or indicates which periodic occurrences of the COT interval are sharable, and wherein the different COT information indicates that the COT interval is to have a different period and/or that different periodic occurrences of the COT interval are to be shareable.
   A6. The method of any of embodiments A1-A5, wherein the COT information indicates a Listen Before Talk, LBT, priority class of data associated with the COT interval, and wherein the different COT information indicates that the COT interval is to be associated with data that has a different LBT priority class.
   A7. The method of any of embodiments A1-A6, wherein the COT information indicates a service type of, logical channel of, logical channel group of, or channel access priority class of data associated with the COT interval, and wherein the different COT information indicates that the COT interval is to be associated with data that has a different service type, a different logical channel, a different logical channel group, or a different channel access priority class.
   A8. The method of any of embodiments A1-A7, wherein the COT information is included in configured grant uplink control information, CG-UCI.
   A9. The method of any of embodiments A1-A7, wherein the COT information is included in a Medium Access Control, MAC, Control Element or in a Radio Resource Control signaling message.
   A10. The method of any of embodiments A1-A9, wherein the different COT information is included in a downlink control information, DCI, message that is addressed to a group of wireless devices including the wireless device or that is addressed to the wireless device.
   A11. The method of any of embodiments A1-A9, wherein the different COT information is included in a Medium Access Control, MAC, Control Element or in a Radio Resource Control signaling message.
   A12. The method of any of embodiments A1-A11, further comprising transmitting capability information indicating whether, or that, the wireless device is capable of receiving different COT information indicating that a COT interval initiated by the wireless device is to have different timing, different shareability, and/or different data prioritization.
   A13. The method of any of embodiments A1-A12, wherein the COT interval is shared with the radio network node, and wherein the method further comprises switching a downlink control channel monitoring pattern that the wireless device uses to monitor a downlink control channel between a slot-based pattern and a mini-slot based pattern based on whether data conveyed in the COT interval is uplink data or downlink data.
   A14. The method of any of embodiments A1-A13, wherein the unlicensed frequency channel is a New Radio Unlicensed channel.
   AA. The method of any of the previous embodiments, further comprising:
providing user data; and
forwarding the user data to a host computer via the transmission to the base station.

### Group B Embodiments

B1. A method performed by a radio network node, the method comprising:
receiving, from a wireless device, channel occupancy time, COT, information indicating timing of, shareability of, and/or data prioritization for a COT interval that the wireless device initiates for occupying an unlicensed frequency channel; and
transmitting, to the wireless device, different COT information indicating that the COT interval initiated by the wireless device is to have different timing, different shareability, and/or different data prioritization.
   B2. The method of embodiment B1, further comprising determining at least one of:
whether the COT interval initiated by the wireless device is to have different timing, different shareability, and/or different data prioritization; or
the different timing, different shareability, and/or different data prioritization.
   B3. The method of embodiment B2, wherein said determining is based on a priority of pending data and/or a priority of data already scheduled to be transmitted to or received from the wireless device within the COT interval, wherein the pending data is data not yet scheduled for transmission or reception.
   B4. The method of any of embodiments B2-B3, wherein said determining is based on a volume of pending data relative to a threshold volume, wherein the pending data is data not yet scheduled for transmission or reception.
   B5. The method of any of embodiments B2-B4, wherein said determining is based on whether the wireless device is capable of receiving different COT information indicating that a COT interval initiated by the wireless device is to have different timing, different shareability, and/or different data prioritization.
   B6. The method of any of embodiments B2-B5, wherein said determining is based on a load of the unlicensed frequency channel and/or a load of a cell, carrier, bandwidth part, or subband with which the unlicensed frequency channel is associated.
   B7. The method of any of embodiments B2-B6, wherein said determining is based on Listen-Before-Talk failure statistics on the unlicensed frequency channel.
   B8. The method of any of embodiments B2-B7, wherein said determining is based on at least one of:
an LBT priority class of, a service type of, a logical channel of, a logical channel group of, or a channel access priority class of data associated with the COT interval; or
an LBT priority class of, a service type of, a logical channel of, a logical channel group of, or a channel access priority class of pending data not yet scheduled for transmission or reception.
   B9. The method of any of embodiments B1-B8, further comprising occupying the unlicensed frequency channel during the COT interval as modified by the radio network node to have the different timing, different shareability, and/or different data prioritization.
   B10. The method of any of embodiments B1-B9, further comprising scheduling data to be transmitted to or received from one or more other wireless devices on the unlicensed frequency channel during the COT interval as modified by the radio network node to have the different timing, different shareability, and/or different data prioritization.
   B11. The method of any of embodiments B1-B10, wherein the COT information indicates that the COT interval is not shareable with the radio network node and/or with other wireless devices, and wherein the different COT information indicates that the COT interval is to be shareable with the radio network node and/or with other wireless devices.
   B12. The method of any of embodiments B1-B11, wherein the COT information indicates a remaining duration of and/or a maximum duration of the COT interval, and wherein the different COT information indicates that the COT interval is to have a different remaining duration and/or a different maximum duration.
   B13. The method of any of embodiments B1-B12, wherein the COT interval is configured to periodically recur, wherein the COT information indicates a period of the COT interval and/or indicates which periodic occurrences of the COT interval are sharable, and wherein the different COT information indicates that the COT interval is to have a different period and/or that different periodic occurrences of the COT interval are to be shareable.
   B14. The method of any of embodiments B1-B13, wherein the COT information indicates a Listen Before Talk, LBT, priority class of data associated with the COT interval, and wherein the different COT information indicates that the COT interval is to be associated with data that has a different LBT priority class.
   B15. The method of any of embodiments B1-B14, wherein the COT information indicates a service type of, logical channel of, logical channel group of, or channel access priority class of data associated with the COT interval, and wherein the different COT information indicates that the COT interval is to be associated with data that has a different service type, a different logical channel, a different logical channel group, or a different channel access priority class.
   B16. The method of any of embodiments B1-B15, wherein the COT information is included in configured grant uplink control information, CG-UCI.
   B17. The method of any of embodiments B1-B15, wherein the COT information is included in a Medium Access Control, MAC, Control Element or in a Radio Resource Control signaling message.
   B18. The method of any of embodiments B1-B17, wherein the different COT information is included in a downlink control information, DCI, message that is addressed to a group of wireless devices including the wireless device or that is addressed to the wireless device.
   B19. The method of any of embodiments B1-B17, wherein the different COT information is included in a Medium Access Control, MAC, Control Element or in a Radio Resource Control signaling message.
   B20. The method of any of embodiments B1-B19, further comprising receiving capability information indicating whether, or that, the wireless device is capable of receiving different COT information indicating that a COT interval initiated by the wireless device is to have different timing, different shareability, and/or different data prioritization.
   B21. The method of any of embodiments B1-B20, wherein the COT interval is shared with the radio network node, and wherein the method further comprises configuring the wireless device to switch a downlink control channel monitoring pattern that the wireless device uses for monitoring a downlink control channel between a slot-based pattern and a mini-slot based pattern based on whether data conveyed in the COT interval is uplink data or downlink data.
   B22. The method of any of embodiments B1-B21, wherein the unlicensed frequency channel is a New Radio Unlicensed channel.
   B23. A method performed by a radio network node, the method comprising:
initiating, or receiving information indicating that a first wireless device has initiated, a first channel occupancy time, COT, interval during which a first transmission is to be performed between the radio network node and the first wireless device on a first set of one or more radio resources within an unlicensed frequency channel; and
controlling initiation of a second COT interval during which a second transmission is to be performed between the radio network node and a second wireless device on a second set of one or more radio resources within the unlicensed frequency channel, wherein the second COT interval at least partly overlaps in time with the first COT interval.
   B24. The method of embodiment B23, wherein the second transmission is allowed during the second COT interval based on a channel sensing procedure performed by the radio network node or the first wireless device for the first COT interval.
   B25. The method of any of embodiments B23-B24, wherein said controlling comprises initiating the second COT interval.
   B26. The method of any of embodiments B23-B24, wherein said controlling comprises scheduling the second transmission to be performed by the second wireless device that is to initiate the second COT interval.
   B27. The method of any of embodiments B23-B26, wherein the second transmission has a priority level that is above a threshold and/or has a priority level that is above a priority level of the first transmission.
   B28. The method of any of embodiments B23-B27, wherein the unlicensed frequency channel is a New Radio Unlicensed channel.
   B29. The method of any of embodiments B23-B28, further comprising transmitting or receiving the second transmission during the second COT interval.
   BB. The method of any of the previous embodiments, further comprising:
obtaining user data; and
forwarding the user data to a host computer or a wireless device.

### Group C Embodiments

C1. A wireless device configured to perform any of the steps of any of the Group A embodiments.
C2. A wireless device comprising processing circuitry configured to perform any of the steps of any of the Group A embodiments.
C3. A wireless device comprising:
communication circuitry; and
processing circuitry configured to perform any of the steps of any of the Group A embodiments.
   C4. A wireless device comprising:
processing circuitry configured to perform any of the steps of any of the Group A embodiments; and
power supply circuitry configured to supply power to the wireless device.
   C5. A wireless device comprising:
processing circuitry and memory, the memory containing instructions executable by the processing circuitry whereby the wireless device is configured to perform any of the steps of any of the Group A embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a wireless device, causes the wireless device to carry out the steps of any of the Group A embodiments.
   C8. A carrier containing the computer program of embodiment C7, wherein the carrier is one of an electronic signal, optical signal, radio signal, or computer readable storage medium.
   C9. A radio network node configured to perform any of the steps of any of the Group B embodiments.
   C10. A radio network node comprising processing circuitry configured to perform any of the steps of any of the Group B embodiments.
   C11. A radio network node comprising:
communication circuitry; and
processing circuitry configured to perform any of the steps of any of the Group B embodiments.
   C12. A radio network node comprising:
processing circuitry configured to perform any of the steps of any of the Group B embodiments;
power supply circuitry configured to supply power to the radio network node.
   C13. A radio network node comprising:
processing circuitry and memory, the memory containing instructions executable by the processing circuitry whereby the radio network node is configured to perform any of the steps of any of the Group B embodiments.
   C14. The radio network node of any of embodiments C9-C13, wherein the radio network node is a base station.
   C15. A computer program comprising instructions which, when executed by at least one processor of a radio network node, causes the radio network node to carry out the steps of any of the Group B embodiments.
   C16. The computer program of embodiment C14, wherein the radio network node is a base station.
   C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the pervious embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and
at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
ACK Acknowledgement
AP Access point
BSR Buffer status report
BW Bandwidth
BWP Bandwidth part
CBG Code block group
CBGTI Code block group transmission indicator
CCA clear channel assessment
CG Configured grant
CG-UCI Configured grant-uplink control information
COT Channel Occupancy Time
CSI Channel State Information
CSI-RS Channel State Information Reference Signal
CWS Contention Window Size
DC Dual connectivity
DCI Down control information
DL Downlink
DRS Discovery reference signal
ED energy detection
eMBB enhanced Mobile broadband
eNB eNodeB (a LTE base station)
FDD Frequency division duplex
GC-PDCCH Group common-Physical downlink control channel
gNB gNodeB a base station supporting the NR radio interface
IE Information Element
IoT Internet of things
LAA Licensed Assisted Access
eLAA enhanced Licensed Assisted Access
feLAA further enhanced Licensed Assisted Access
LBT Listen-before-talk
LCH Logical channel
LCG Logical channel group
LTE Long Term Evolution
MAC Medium access control
MAC CE MAC Control Element
MBB Mobile broadband
MCOT Maximum COT
MCS Modulation coding scheme
NR New Radio
NR-U NR unlicensed
OFDM Orthogonal frequency division multiplexing
OFDM PHYs OFDM physical layers
PBCH Physical Broadcast Channel
PDCCH Physical Downlink Control Channel
PDU Protocol data unit
PHY Physical
PRACH Physical Random Access Channel
PSS Primary synchronization signal
PUCCH Physical Uplink Control Channel
PUSCH Physical Uplink Shared Channel
QoS Quality of service
RAT Radio Access Technology
RMTC RSSI measurement timing configuration
RRC Radio resource control
RRM Radio Resource Management
RSRP Reference Signal Received Power
RSRQ Reference Signal Received Quality
RSSI Received signal strength indicator
SFI Slot format indicator
SIFS Short interframe space
SR Scheduling Request
SRS Sounding Reference signal
SSS Secondary synchronization signal
STA Station
TBS Transport block size
TDD Time division duplex
Tx Transmitter
TXOP Transmission opportunity
UCI Uplink control information
UE User equipment
UL Uplink
1× RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDUCommon Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the
band
CQI Channel Quality information
C-RNTI Cell RNTI
CSI Channel State Information
DCCH Dedicated Control Channel
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
OCNG OFDMA Channel Noise Generator
OFDMA Orthogonal Frequency Division Multiple Access
OSS Operations Support System
OTDOA Observed Time Difference of Arrival
O&M Operation and Maintenance
P-CCPCH Primary Common Control Physical Channel
PCell Primary Cell
PCFICH Physical Control Format Indicator Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
RACH Random Access Channel
QAM Quadrature Amplitude Modulation
RAN Radio Access Network
RLM Radio Link Management
RNC Radio Network Controller
RNTI Radio Network Temporary Identifier
RRC Radio Resource Control
RS Reference Signal
RSCP Received Signal Code Power
RSRP Reference Symbol Received Power OR Reference Signal Received Power
RSRQ Reference Signal Received Quality OR Reference Symbol Received Quality
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
TDOA Time Difference of Arrival
TOA Time of Arrival
TSS Tertiary Synchronization Signal
TTI Transmission Time Interval
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1.-41. (canceled)

42. A method performed by a wireless device, the method comprising:
transmitting, to a radio network node, channel occupancy time (COT) information indicating timing of, shareability of, and/or data prioritization for a COT interval that the wireless device initiates for occupying an unlicensed frequency channel; and
receiving, from the radio network node, different COT information indicating that the COT interval initiated by the wireless device is to have different timing, different shareability, and/or different data prioritization.

43. The method of claim 42, further comprising occupying the unlicensed frequency channel during the COT interval as modified by the radio network node to have the different timing, different shareability, and/or different data prioritization.

44. The method of claim 42, wherein the COT information indicates that the COT interval is not shareable with the radio network node and/or with other wireless devices, and wherein the different COT information indicates that the COT interval is to be shareable with the radio network node and/or with other wireless devices.

45. The method of claim 42, wherein the COT information indicates a remaining duration of and/or a maximum duration of the COT interval, and wherein the different COT information indicates that the COT interval is to have a different remaining duration and/or a different maximum duration.

46. A wireless device comprising:
communication circuitry; and
processing circuitry configured to:
transmit, to a radio network node, channel occupancy time (COT) information indicating timing of, shareability of, and/or data prioritization for a COT interval that the wireless device initiates for occupying an unlicensed frequency channel; and
receive, from the radio network node, different COT information indicating that the COT interval initiated by the wireless device is to have different timing, different shareability, and/or different data prioritization.

47. The wireless device of claim 46, wherein the wireless device is further configured to occupy the unlicensed frequency channel during the COT interval as modified by the radio network node to have the different timing, different shareability, and/or different data prioritization.

48. The wireless device of claim 46, wherein the COT information indicates that the COT interval is not shareable with the radio network node and/or with other wireless devices, and wherein the different COT information indicates that the COT interval is to be shareable with the radio network node and/or with other wireless devices.

49. The wireless device of claim 46, wherein the COT information indicates a remaining duration of and/or a maximum duration of the COT interval, and wherein the different COT information indicates that the COT interval is to have a different remaining duration and/or a different maximum duration.

50. The wireless device of claim 46, wherein the COT information indicates a Listen Before Talk (LBT) priority class of data associated with the COT interval, and wherein the different COT information indicates that the COT interval is to be associated with data that has a different LBT priority class.

51. A radio network node comprising:
communication circuitry; and
processing circuitry configured to:
receive, from a wireless device, channel occupancy time (COT) information indicating timing of, shareability of, and/or data prioritization for a COT interval that the wireless device initiates for occupying an unlicensed frequency channel; and
transmit, to the wireless device, different COT information indicating that the COT interval initiated by the wireless device is to have different timing, different shareability, and/or different data prioritization.

52. The radio network node of claim 51, wherein the processing circuitry is further configured to make a determination of at least one of:
whether the COT interval initiated by the wireless device is to have different timing, different shareability, and/or different data prioritization; or
the different timing, different shareability, and/or different data prioritization.

53. The radio network node of claim 52, wherein the processing circuitry is configured to make the determination based on a priority of pending data and/or a priority of data already scheduled to be transmitted to or received from the wireless device within the COT interval, wherein the pending data is data not yet scheduled for transmission or reception.

54. The radio network node of claim 52, wherein the processing circuitry is configured to make the determination based on a volume of pending data relative to a threshold volume, wherein the pending data is data not yet scheduled for transmission or reception.

55. The radio network node of claim 51, further configured to:
occupy the unlicensed frequency channel during the COT interval as modified by the radio network node to have the different timing, different shareability, and/or different data prioritization; or
schedule data to be transmitted to or received from one or more other wireless devices on the unlicensed frequency channel during the COT interval as modified by the radio network node to have the different timing, different shareability, and/or different data prioritization.

56. The radio network node of claim 51, wherein the COT information indicates that the COT interval is not shareable with the radio network node and/or with other wireless devices, and wherein the different COT information indicates that the COT interval is to be shareable with the radio network node and/or with other wireless devices.

57. The radio network node of claim 51, wherein the COT information indicates a remaining duration of and/or a maximum duration of the COT interval, and wherein the different COT information indicates that the COT interval is to have a different remaining duration and/or a different maximum duration.

58. The radio network node of claim 51, wherein the COT information indicates a Listen Before Talk (LBT) priority class of data associated with the COT interval, and wherein the different COT information indicates that the COT interval is to be associated with data that has a different LBT priority class.

59. A radio network node comprising:
communication circuitry; and
processing circuitry configured to:
initiate, or receive information indicating that a first wireless device has initiated, a first channel occupancy time (COT) interval during which a first transmission is to be performed between the radio network node and the first wireless device on a first set of one or more radio resources within an unlicensed frequency channel; and
control initiation of a second COT interval during which a second transmission is to be performed between the radio network node and a second wireless device on a second set of one or more radio resources within the unlicensed frequency channel, wherein the second COT interval at least partly overlaps in time with the first COT interval.

60. The radio network node of claim 59, wherein the second transmission is allowed during the second COT interval based on a channel sensing procedure performed by the radio network node or the first wireless device for the first COT interval.

61. The radio network node of claim 59, wherein the second transmission has a priority level that is above a threshold and/or has a priority level that is above a priority level of the first transmission.
